(19) United States
(12) Patent Application Publication
(10) Pub. No.: US 2012/0040872 A1
(43) Pub. Date: Feb. 16, 2012

(54) PREPARING CARBOHYDRATE MICROARRAYS AND CONJUGATED NANOPARTICLES

(75) Inventor: Xichun Zhou, Littleton, CO (US)

(73) Assignee: ADA TECHNOLOGIES, INC., LITTLETON, CO (US)

(21) Appl. No.: 13/280,155

(22) Filed: Oct. 24, 2011

Related U.S. Application Data
(63) Continuation of application No. 12/074,887, filed on Mar. 7, 2008.
(60) Provisional application No. 60/893,542, filed on Mar. 7, 2007.

(51) Int. Cl. C40B 50/18; C40B 50/14; B82Y 40/00

(52) U.S. Cl. 506/32; 506/30; 977/902

(57) ABSTRACT

The present invention is directed to carbohydrate microarray and conjugated nanoparticles methods of making the same.

### CROSS REFERENCE TO RELATED APPLICATIONS

The present application is a continuation of U.S. application Ser. No. 12/074,887, filed Mar. 7, 2008, which claims the benefit of U.S. Provisional Application No. 60/893,542, filed on Mar. 7, 2007, the entire contents of each are incorporated herein by reference in their entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant Nos. 1R43RR023763-01 and 1R43GM081972-01 awarded by the National Institute of Health.

### FIELD OF THE INVENTION

This invention relates generally to carbohydrate microarrays and carbohydrate conjugated nanoparticles, and specifically to carbohydrate microarrays having one or more carbohydrates immobilized on a substrate.

### BACKGROUND

Carbohydrates, nucleic acids, lipids, and proteins carry important biological information. Of the four, carbohydrates are the most abundant, forming structural components and storing and transporting biological information within living things. Carbohydrates are prominently displayed on the surface of cell membranes and expressed by virtually all secretory proteins in bodily fluids. This is achieved by the events of posttranslational protein modification, called glycosylation. Expressions of cellular glycans are regulated differently in the form of either glycoproteins or glycolipids. Cell-display of precise complex carbohydrates are characteristically associated with the stages or steps of embryonic development, cell differentiation, as well as transformation of normal cells to abnormally differentiated tumor or cancer cells. Sugars are also abundantly expressed on the outer surfaces of the majority of viral, bacterial, protozoan and fungal pathogens. Many sugar structures are pathogen-specific, making them important molecular targets for pathogen recognition, diagnosis of infectious diseases, and vaccine development.

The basic carbohydrate unit is a monosaccharide, an organic molecule comprised of a carbonyl group and one or more hydroxyl groups. The monosacchardies are typically cyclic and cannot be hydrolyzed to smaller carbohydrates. Monosaccharides are classified by the placement of the carbonyl group, the number of carbon atoms, and stereochemistry. The carbonyl group can be a ketone (in which case the monosaccharide is a ketose) or aldehyde (in which case the monosaccharide is an aldose). Monosaccharides typically have three or more carbon atoms; monosaccardies with three carbon atoms are called trioses, those with four tetroses, those with five petoses, and those with six hexoses, and so forth. The carbon atoms, particularly, the hydroxyl substituted carbon atoms, can be asymmetric, thereby, producing stereocenters. The hydroxyl groups are on most, if not all, of the non-carbonyl atoms. The stereocenters have two configurations, namely R or S, with the asymmetry of the stereocenters making possible a variety of isomers for any given monosaccharide. For example, aldohexose, where all but two of the six carbon atoms are stereogenic, has sixteen possible stereoisomers.

The carbohydrate monosaccharide units can be combined to form disaccharides, oligosaccharides, and polysaccharides. A disaccharide comprises two monosaccharides, which may or may not be the same. Disaccharides are typically classified as reducing disaccharides, where the monosaccharide components are bonded by hydroxyl groups, or non-reducing disaccharides, and by their anometric centers.

A polysaccharide is a complex carbohydrate comprising a number of monosaccharides joined together by glycosidic bonds. When the monosaccharides comprising the polysaccharide are the same, the polysaccharide is a homopolysaccharide, and when the monosaccharides differ a heteropolysaccharide. Typically, polysacchardies comprise three or more monosaccharides, and even more typically comprise from about 40 to about 3500 monosaccharides. Polysaccharides can be linear or branched.

An oligosaccharide is a type of polysaccharide containing, typically, three to ten monosaccharides. Oligosaccharides are, typically, a component of glycoproteins or glycolipids and are typically O- or N-linked to amino acid side chains in proteins or to lipid entities.

Recently, a growing interest has emerged to better understand the biological functions and physiological roles of carbohydrates and glycol-conjugates. Recent findings show that oligosaccharides play a vital roll in a variety of fundamental cellular processes, controlling many normal and pathological processes. One such process is glycosylation, the process of adding a saccharide to a protein or lipid in the synthesis of a membrane and/or secreted protein. As such, carbohydrates are prominently displayed on cell surface membranes and present in virtually all secreted proteins contained in bodily fluids. Two types of glycosylation exist: N- and O-linked. In N-linked glycosylation, the polysaccharide is linked to an amide nitrogen, such as, an asparagine side chain, and, in O-linked glycosylation, the polysaccharide is linked to a hydroxyl oxygen, such as, a serine or threonine side chain. The attachment of the polysaccharide to the protein serves various functions. For example, glycosylation is required for some proteins to fold correctly or to confer stability to some secreted proteins.

Carbohydrates are an agent of communication between various biological-molecules and/or cells. Some of these communications are in the form of glycopeptides; glycolipids, glycosaminoglycans, and proteoglycans. Carbohydrates can also be expressed on the outer surface of a majority of viral, bacterial, protozoan, and fungal pathogens. The structural expression of carbohydrates can be pathogen-specific, making carbohydrates an important molecular target for pathogen recognition and/or infectious diseases diagnosis. For example, carbohydrates are involved in inflammation, cell-cell interactions, signal transduction, fertility, bacteria-host interactions, viral entry, cell differentiation, cell adhesion, immune response, trafficking, and tumor cell metastasis. This pathogen specific expression of carbohydrates can aid in vaccine development.

One feature of the post-genomic period is the exploration of biophysical, biochemical, and immunological properties of carbohydrate-carbohydrate and carbohydrate-protein interactions. Thus, a method is needed to study protein-carbohydrate interactions and to better understand these important biological processes. The development of DNA and protein microarrays represents a significant advance in transcriptomics and proteomics research. Such arrays can allow high-throughput, parallel analysis of protein occurrence, protein interactions and gene expression.

Glycomics, the comprehensive study of glycomes, focuses on the interactions of carbohydrates with other biological processes. Cabrohydrate microarrays are a platform for glycomic studies probing the interactions of carbohydrates with other biopolymers and biomaterials, in a versatile, rapid, and efficient manner. Glycomic studies involve the physiologic, pathologic, and other associated aspects of carbohydrates, including, without limitation, carbohydrates in a cell. One particular advantage of the carbohydrate microarray is that a glycomic analysis requires only picomoles of a material and permits typically hundreds of interactions to be screened on a single microarray. The miniaturized array methodology is particularly well suited for investigations in the field of glycomics, since biological amplification strategies, such as the Polymerase Chain Reaction (PCR) or cloning, do not exist to produce usable quantities of complex oligosaccharides. Presenting carbohydrates in a microarray format can be an efficient way to monitor the multiple binding events of an analyte, such as, a protein interacting with one or more carbohydrates immobilized on a microarray surface.

Various approaches have been attempted to immobilize carbohydrates on a solid surface for conducting functional glycomics. Generally, the prior art for immobilizing a carbohydrate on a solid surface can be characterized by more or more of the following:
1. the carbohydrate is or is not site-specifically immobilized on the solid surface;
2. the carbohydrate is or is not covalently immobilized on the solid surface;
3. the carbohydrate is or is not modified prior to immobilization; and
4. the solid surface is or is not modified prior to immobilizing the carbohydrate.

FIGS. 1A-D depict prior art immobilizations of a carbohydrate on a substrate.

FIG. 1A depicts a carbohydrate 100 immobilized on a surface 102 in a non-specific, non-covalent manner to form an immobilized carbohydrate 104. The surface 102 does not efficiently immobilize or retain small carbohydrates.

Another prior art immobilized carbohydrate is depicted in FIG. 1B. A chemically modified carbohydrate 111 is site-specifically, covalently immobilized on a modified surface 112 to form a site-specific immobilized carbohydrate 114. The modified surface 112 is formed by introducing a number of chemical active groups 116 (such as thiol, amine, epoxy, aldehyde, maleimide or N-hydroxysuccinimide) on the surface 102. The modified carbohydrate 111 is formed from the carbohydrate 100 by introducing a modification 118. While simple carbohydrates and oligosaccharides can be efficiently immobilized in a site-specific manner, the immobilization process is complex and time consuming. Additionally, the carbohydrate 100 requires modification, which can affect the glycomic response of the immobilized carbohydrate 114. Moreover, it is impractical to modify many of carbohydrates extracted from nature sources.

FIG. 1C depicts yet another immobilized carbohydrate, the modified carbohydrate 111 is site-specifically immobilized on the surface 102 to form a site-specifically, non-covalently immobilized carbohydrate 121. This method requires that the carbohydrate 100 be modified, which can affect the glycomic response of the immobilized carbohydrate 121. Moreover, it is impractical to modify many of carbohydrates extracted from nature sources

In FIG. 1D, the carbohydrate 100 is site-specifically, immobilized on the modified surface 112 to form immobilized carbohydrate 144. Carbohydrates immobilized in this manner can be suitable for carbohydrate-protein interaction studies. In-Jae et al. teach in U.S. Patent Application No. 2006/025,030 a method of immobilizing a non-modified carbohydrate to a 2-dimensional, linear-linkage attached to a substrate. Zhou et al. teach a two-dimensional, linkage system method of immobilizing carbohydrates on a glass substrate (Biosensors and Bioelectronics, 21 (2006) 1451-1458). A two-dimensional linkage system mean one end of the linkage immobilizes the carbohydrate and the other end of the linkage is immobilized to the substrate. Or stated another way, a two-dimensional linkage system means that, for a selected site on the substrate, the linkage immobilizes only one carbohydrate.

While the above immobilized carbohydrates 106, 116, 121, and 144 can be suitable for carbohydrate-protein interaction studies, they are tedious and laborious to prepare and have a low signal-to-noise ratio. Compared to protein-protein interaction, the carbohydrates on a solid support is required to provide a detectable carbohydrate-protein interaction having a multivalency between carbohydrate and protein. A critical need persists for a more robust and less tedious process to covalently and site-specifically immobilize a variety of structurally and chemically diverse non-modified carbohydrates in a fast and cost efficient manner for the glycomic analysis of carbohydrates and carbohydrate cellular receptors. Additionally, a need persists for a high-throughput, carbohydrate microarray for performing functional studies, more specifically, a carbohydrate microarray configured to better understand and characterize the biological, bio-chemical, and/or immunological interactions of carbohydrates.

### SUMMARY

It is to be understood that the present invention includes a variety of different versions or embodiments, and this Summary is not meant to be limiting or all-inclusive. This Summary provides some general descriptions of some of the embodiments, but may also include some more specific descriptions of certain embodiments.

One embodiment uses one or more linking compounds, each of which includes multiple surface groups and is bonded to a site on a substrate (e.g., a microarray or nanoparticle) to attach to carbohydrates. A linking compound has a first end attached, typically by a covalent bond, to a site on the substrate and one or more other ends attached, typically by a covalent bond, to one or more carbohydrates. The site is a chemical entity reactive with the linking compound. Examples of reactive entities include, without limitation, any organofunctional group (e.g., epoxy groups, nitrogen functional groups, and hydroxyl groups) and an inorgamic species (e.g., metals and metallic species.) In one configuration, the linking compound includes a three-dimensional (3D) dendrimer attached directly (e.g., by a link directly to a dendrimer) or indirectly (e.g., by a silane coupling agent and other suitable coupling agents), to the site and directly to the carbohydrates. For example, the three-dimensional dendrimer is generally a molecular entity having two or more surface groups for immobilization of (or linking with) carbohydrates and one or more (identical or different) surface groups for immobilization on (or attaching to) a substrate. As can be appreciated, the surface groups can be chemically changed or altered; that is, the groups can be derivatized to form derivatized groups, which can bond to a carbohydrate and/or substrate. This configuration can provide a robust, highly responsive, and cost effective microarray while improving the precision, accuracy, and sensitivity of a glycomic analysis of the carbohydrate with a biological material. In addition, a high density of immobilized carbohydrate can be achieved on the three-dimensional dendrimer. The high carbohydrate density provides for the needed multiple covalent interactions between the carbohydrates and protein.

A number of differing carbohydrates can be arranged in an array for conducting a number of different glycomic analyses. The glycomic analyses, for example, can be performed using one or more of: fluorescence, raman, infrared, near infrared, visible, or ultra violet spectroscopy; magnetic resonance imaging; electrochemical potentials and/or voltages, and chemilluminesence

Another embodiment provides a method of immobilizing a three-dimensional dendrimer on a substrate; preferably by covalently bonding the three-dimensional dendrimer to the substrate. Preferrably, the immobilized three-dimensional dendrimer substantially forms a mono-layer, or single-atom or single-molecule thick layer, on the substrate. As can be appreciated, the substrate can be any substrate that can immobilize the three-dimensional dendrimer and have any geometric shape; with preferred shapes being substantially flat planar and approximately spherical. In one aspect, the approximately spherical substrate comprises nanoparticles.

Another embodiment immobilizes one or more carbohydrates to a previously immobilized three-dimensional dendrimer, with the carbohydrate(s) being covalently immobilized. The one or more covalently immobilized carbohydrates, preferably form a mono-layer on the immobilized three-dimensional dendrimer. Or stated another way, the substrate comprises a mono-layer having one or more carbohydrates immobilized on the three-dimensional dendrimer bonded to the substrate. The high concentration of carbohydrate immobilization can increase the level of detection and precision of the glycomic analysis.

Carbohydrate microarrays prepared by this embodiment can be less tedious and require less time to prepare and have lower detection limits than carbohydrate arrays prepared by prior art methods.

An aspect of this embodiment immobilizes the carbohydrate to the three-dimensional dendrimer already previously immobilized on a metal or metallic substrate and/or a metal or metallic layer on a non-metallic substrate.

Yet another embodiment is a microarray comprising a three-dimensional dendrimer positioned between one or more carbohydrates and a substrate. The three-dimensional dendrimer is covalently bonded both to the carbohydrates and to the substrate. In one aspect, the covalently bonded carbohydrates are unmodified carbohydrates. The unmodified carbohydrates have an affinity for lectins, proteins, and/or antibody, DNA.

Another embodiment intermolecularly cross-links two or more immobilized three-dimensional dendrimers to form a cross-linked layer, where the two or more three-dimensional dendrimers covalently bonded by a cross-linker. The cross-linked layer is believed to improve the stability of the immobilized layer to washing and regeneration conditions during glycomic analysis.

Still yet another embodiment is a method of preparing poly-covalently functionalized particles having a number of carbohydrate molecules attached thereto. Preferably, the functionalized particle diameter ranges from about one hundred micrometer to about one nanometer. In one aspect, the functionalized particles can be used in-situ and/or in vivo analysis for probing carbohydrate interactions, such as, but not limited to, in vivo analysis by injection to a living being and/or plant.

Preferred carbohydrate molecules are one or more of monosaccharides, oligosaccharides, polysaccharides, glycan-peptides and glycan-proteins.

Another embodiment immobilizes a, commonly unmodified (or without chemical manipulation), carbohydrate to an organic substance using microwave radiation energy. Microwaves accelerate chemical and biochemical reactions by providing heat, where the quantity of heat supplied essentially follows microwave dielectric loss. However, many microwave assisted reactions cannot be explained by heating alone. For example, nonpolar molecules having lower dielectric constants absorb low levels of microwave energy and therefore supply little, if any, thermal energy. The dielectric constant and the ability of a molecule to be polarized by an electric field together indicate the capacity of the molecule to be microwave heated. For metals, the attenuation of microwave radiation arises from the creation of currents resulting from charge carriers being displaced by the electric field. This method is especially useful for complex oligosaccharides isolated from natural sources.

The various embodiments can provide a number of advantages, depending on the configuration. For example, carbohydrate microarray fabrication can be performed without prior chemical derivatization of the carbohydrate being used to covalently immobilize on a selected surface. Investigation of carbohydrate-protein interactions with carbohydrate microarrays can be facilitated by immobilizing the carbohydrates in site-specific format for eludication of the structural specific protein interaction. By using dendrimers to fix the carbohydrates to the selected surface, a high density of carbohydrates per unit area can be realized, thereby increasing the likelihood of protein-carbohydrate interactions. Dendrimers can be functionalized with active groups due to their well-defined composition and constitution and narrow molecular weight distribution. Glyco-nanoparticles, or carbohydrate functionalized nanoparticles, and microarrays can be fabricated easily and rapidly using miniaturized microwave radiation energy, with nanoparticle having multiple carbohydrate moieties, thereby providing an increased potential for the enhancement of biomolecular interaction.

These and other advantages will be apparent from the description presented below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The terms “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

Various embodiments of the present invention are set forth in the attached figures and in the detailed description of the invention as provided herein and as embodied by the claims. It should be understood, however, that this Summary does not contain all of the aspects and embodiments of the present invention, is not meant to be limiting or restrictive in any manner, and that the invention as disclosed herein is and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

FIG. 1A depicts a carbohydrate immobilized on a substrate by a prior art method;

FIG. 1B depicts a modified carbohydrate immobilized on a modified substrate by another prior art method;

FIG. 1C depicts a modified carbohydrate immobilized on a substrate by another prior art method;

FIG. 1D depicts a carbohydrate immobilized on a modified substrate by another prior art method;

FIG. 2 depicts a process for preparing a 3-D array substrate according to an embodiment of the invention;

FIG. 3 depicts a substrate of another embodiment of the invention;

FIG. 4 depicts a modified substrate of another embodiment of the invention;

FIG. 5 depicts an immobilized first substance immobilized according to another embodiment of the invention;

FIGS. 6A-H depicts aspects of a 3-D substance according to another embodiment of the invention;

FIG. 7 depicts an immobilized 3-D substance according to another embodiment of the invention;

FIG. 8 depicts an immobilized derivatized 3-D substance according to another embodiment of the invention;

FIG. 9 depicts a carbohydrate immobilized on an immobilized derivatized 3-D substance according to another embodiment of the invention;

FIG. 10 depicts a process for preparing a carbohydrate microarray according to another embodiment of invention;

FIG. 11 depicts another carbohydrate microarray according to another embodiment of the invention;

FIGS. 12A-C depict carbohydrate microarrays according to other embodiments of the invention;

FIG. 13 depicts a comparison of another microarray according to another embodiment of the invention to a microarray of the prior art;

FIG. 14 depicts a cross-linked immobilized 3-D substance according to another embodiment;

FIG. 15 depicts a process for preparing a conjugated nonoparticles; and

FIGS. 16A-C depict conjugated nanoparticles according to an embodiment of the invention.

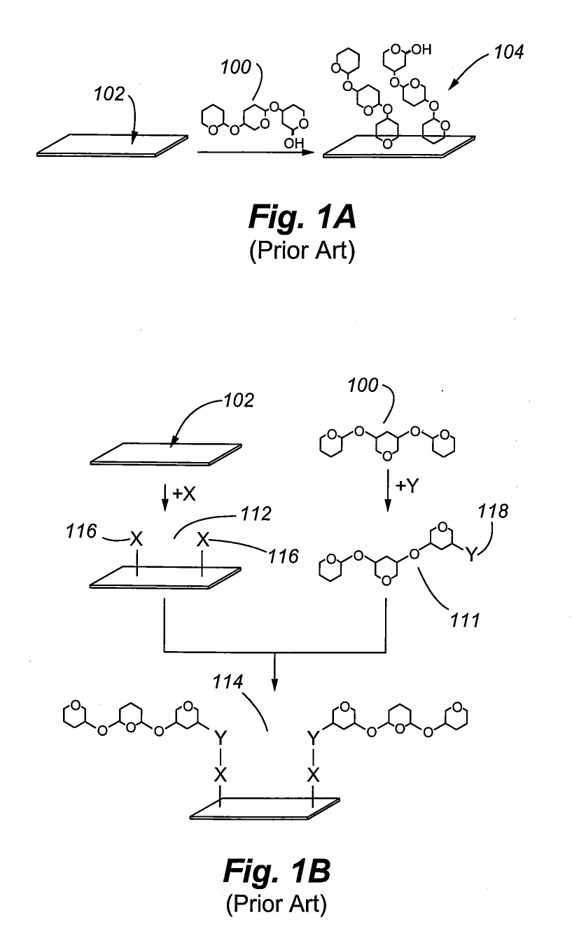

### DETAILED DESCRIPTION

A method for fabricating carbohydrate microarrays and carbohydrate particles is provided using microwave energy to fix, preferably unmodified carbohydrate candidates, such as monosaccharides, oligosaccharides, polysaccharides, glycopeptides, and glycoproteins, on the three-dimensional surface of substrates or the surfaces of particles through the reactivity of the reducing end of the carbohydrates. The carbohydrates are bonded to the three-dimensional surface of the substrate or particles (such as micrometer to nanometer diameter particles of a desirable shape (e.g., spherical, cylindrical, and wire-like) made by silica, metal, semiconductor, polymer, and composites thereof) in site-specifically via the formation of one or more bonding mechanisms, including without limitation amide linkage, oxime linkage, glycosyl linkage, thiozolidine linkdage, and the like, to provide polycovalent or multiple-covalent binding interactions for glycomic analysis of proteins, include lectins, antibodies, DNA, and peptides.

To promote formation of the linkages, the substrate can include a layer of a dendrimeric three-dimensional organic or polymer film with the outermost functional groups including, for example, the functional groups: amino, aminooxy, hydrazide, glycosyl hydrazide, cysteine, glutamic acid, and diazrine.

The affinity interaction of the carbohydrate-containing molecules to the binding molecules can be measured by optical (UV-Vis), fluorescence, surface-enhanced fluorescence, surface plasmon resonance, surface-enhanced Raman scattering microscopy, or electrochemical and chemilluminescent techniques. Commonly, the detection method is direct immunoassay, sandwich immunoassay with a labeling or unlabeling approach, with the binding molecules being, for example, lectin, protein, peptide, or DNA.

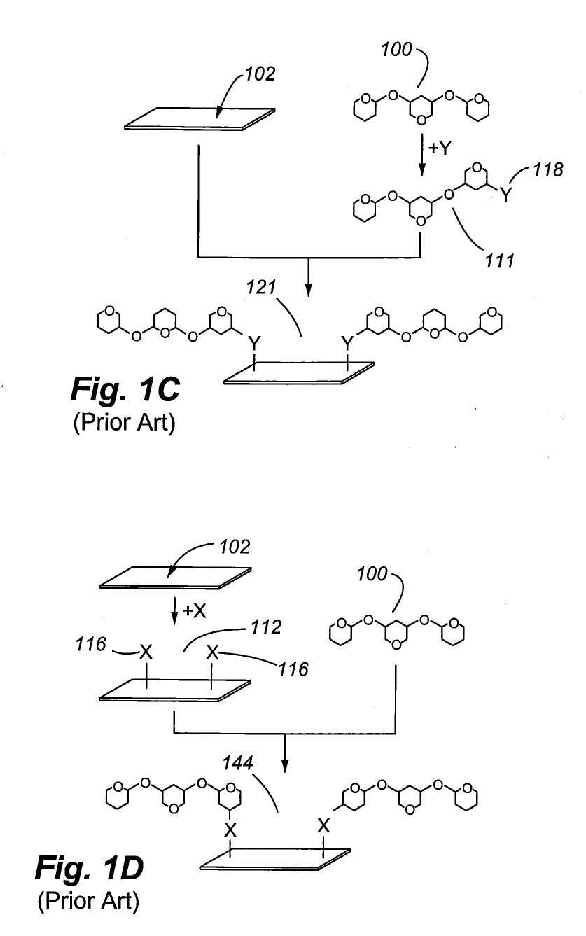

FIG. 2 depicts the method for preparing an array substrate 269. While the method is described with reference to a multiple format substrate, such as a microarray, it is to be understood that it can be applied to a single format substrate, such as a nanoparticle.

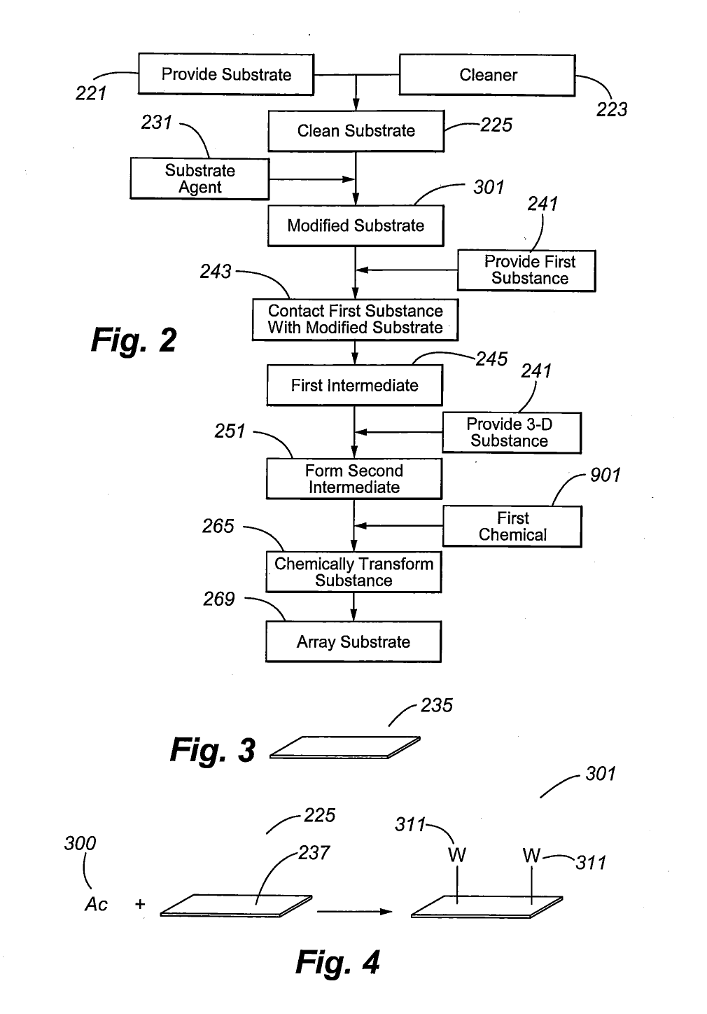

In step 221, a substrate 235 (FIG. 3) is provided. The substrate 235 and a cleaner 223 are contacted to produce a clean substrate 225. The substrate 235 can be any suitable solid material, including without limitation solid materials formed from or containing silicons (such as, but not limited to semi-conductors), organic polymers (e.g., cellulosic paper, polymeric membranes, and the like), inorganic polymers (e.g., membranes), micas, minerals, quartzes, plastics, glasses, metals and metal alloys (such as, copper, platinum, palladium, nickel, cobalt, rhodium, iridium, gold, silver, titanium, and aluminum), and combinations or composites thereof. More preferred solid materials are fabricated from or comprise quartz, glass, paper, gold, silver, titanium, aluminum, copper, nickel, silicon, or organic polymer. Even more preferably, the substrate 235 is a microscope glass slide (e.g., Corning™, Corning, N.Y.), silicon wafer, or quartz.

The substrate 235 can have any three-dimensional geometric shape. Preferably, the substrate 235 is substantially a flat plane or approximates one of a sphere, cylinder, or wire.

The cleaner 223 can include any suitable cleaning substance and be performed by any suitable process. Cleaning substance can be, for instance, any solid, liquid (organic and/or inorganic) and/or gas capable of cleaning the substrate 235. Exemplary cleaning substances include a solid pumice, or a liquid etchant, surfactant, or solvent, or a gaseous etchant or solvent, and mixtures thereof.

In one configuration, the cleaner 223 is a solvent capable of solubilizing (and/or dispersing and/or physically removing) contaminants on the substrate 235. The contaminants can be one or more of particulates (dust, dirt, chips, solid, etc.), greases, fats, oils, waxes, or other physical matter. The cleaner 223 includes an aqueous agent (such as, aqueous surfactant system), semi-aqueous agent (such as, an emulsion of solvents and water), hydrocarbon solvent, and/or halogenated solvent. Preferably, the cleaner 223 is a degreaser, more preferably an organic degreaser, such as, but not limited to, one or more of a halogenated, non-halogenated, perchloroethyelene, trichloroethylene, methylene choloride, alcoxypropanol, modified non-halogenated alcohol solvents, or mixtures thereof. Even more preferably, the cleaner 223 is methylene chloride (CH₂Cl₂). The cleaner 223 can be applied in a vapor spray, immersion/vapor spray, or an ultrasonic immersion/vapor spray. When the cleaner 223 is methylene chloride, the substrate 235 is immersed in the methylene chloride and ultrasonic energy is commonly applied during immersion. Typical immersion times range from about 1 minute to about 240 minutes, more typically, about 5 minutes to about 60 minutes.

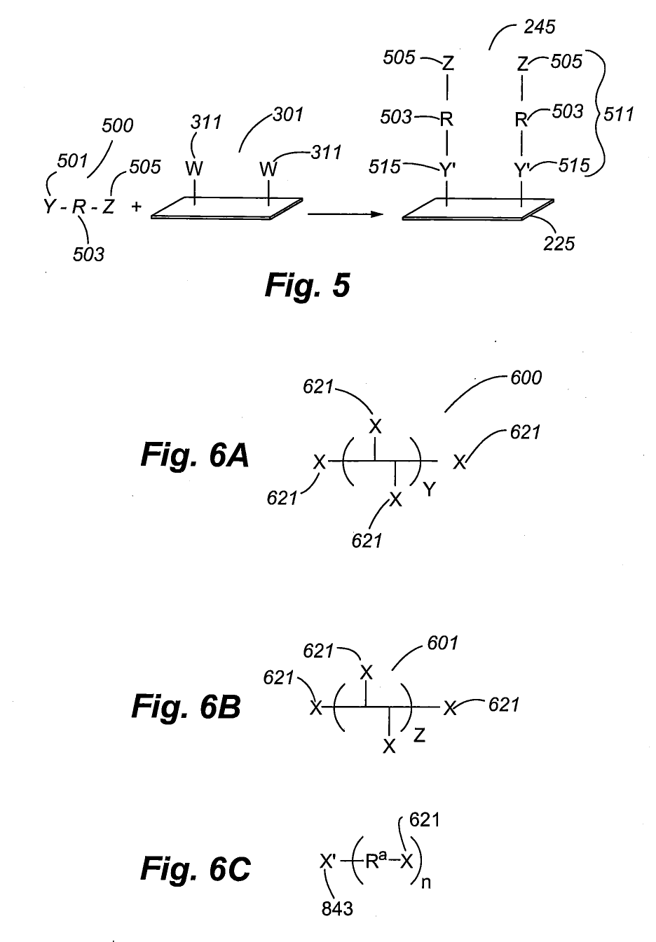

In step 231, a substrate agent 300 (FIG. 4) is provided. The substrate agent 300 is contacted with the clean substrate 225 forming a modified substrate 301 having a number of surface functional groups 311. The substrate agent 300 can be any chemical substance and/or any chemical process, that induces a change to a surface 237 of the clean substrate 225 (or the substrate 235). The change is the formation and deposition, on the substrate 235, of surface functional groups 311. The surface functional groups 311 are commonly any chemical group, such as, but not limited to, hydroxyls (—OH), carbonyls (—C═O, including ketones, aldhedyes, esters, carboxylic acids and carboxylates), maleimide, sulfies (—SH, —S, —SR, ═S, —SO, or such), aminos (—NH and/or —NH2, including amides), azide, benzoquinone, halides (including halogens), and metals (as for example, Ag, Au, Ti, Al, Pt, Cu, Pa, Co, Rh, Ir, and their alloys such as, but not limited to metallics containing nitrogen, oxygen, sulfur, phosphorous).

In one configuration, the functional group 311 is a metal (or alloy) atoms applied by a suitable metal deposition and/or metal conversion process (such as, oxidation). The metal deposition process can be, for example, one or more of a vapor, solution, reactive, laser sintering, e-beam, filament, sputtering, thermal spray, electric arc, combustion torch, combustion, plasma spray, ion plating, ion implantation, laser alloying, chemical vapor, or electrochemical process.

In one configuration, the number of surface groups 311 includes a chemical-functional group (that is, hydroxyl, carbonyl, amino, sulfic, imidazole, and/or halide), and the substrate agent 300 is a chemical substance and/or process modification of the clean surface 225 (or substrate 235) to produce such surface groups 311. When the surface groups 311 are one or more of carbonyls, hydroxyl, and/or sulfic, imidazole, the preferred substrate agent 300 is typically an oxidizer, such as, but not limited to, chromic acid, piranha solution, corona discharge, flame, thermal, plasma, sodium naphthalene and/or sodium-ammonia complex in ammonia, amminoization, sulfization or halogenization.

When the substrate 235 is one of glass, silicon, or quartz, the preferred surface agent 300 is a piranha solution. Piranha solution (or piranha etch) refers to a strongly oxidizing aqueous mixture of sulfuric acid (H₂SO₄) and hydrogen peroxide (H₂O₂), that can be combined in many different ratios depending on the application. A preferred composition is a ratio of 95 v % H₂SO₄:5 v % H₂O₂ varying from about 1:1 to about 10:1. For cleaning quartz or glass, a more preferred ratio is about 3:1. The Piranha solution is capable of removing most organic residues and of hydroxylating (that is, adding —OH groups) to the surface. When the substrate 235 is quartz or glass, the strongly oxidizing surface agent 300 makes the surface 225 (or 235) hydrophilic and increases the number of hydroxyl (—OH) groups on the surface.

In one configuration, the surface groups 311 are formed on the surface 237 of the clean substrate 225 (or of the substrate 235 or modified substrate 301) by the chemical reaction of a solution of 1,1′-carbonyldiimidazole with the surface 237. Preferably, the reaction product is a number of imidazole surface groups 311.

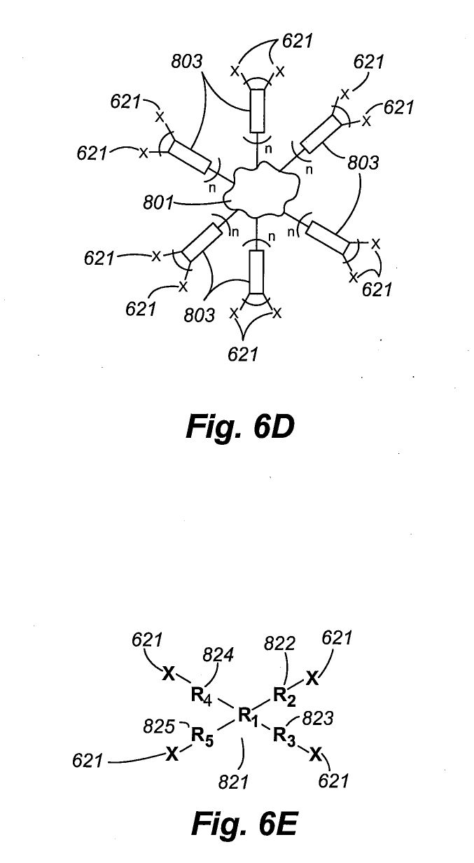

A first substance 500 is provided in subsequent step 241. In one embodiment, the first substance 500 (FIG. 5) has a structure of Y—R—Z, where Y is a first group 501, R is a radical group 503, and Z is a second group 505.

The first group 501 is capable of chemically reacting with the surface groups 311 to form a covalent bond as depicted below:

Y—R—Z+substrate-W→Z—R—Y′-substrate (1)

where “W” is one of the number of surface groups 311.

The first group 501 can be any organic or inorganic functional group, including without limitation silanes, amines, amides, thiols, disulfides, amides, carboxylic acids, acid chlorides, phosphates, phosphate esters, alklenes, alkynes, epoxy (or oxiranes), aldehydes, maleimides, azides, benzoquinones, halogens, hydroxyls, esters, alcohols, their sulfur, nitrogen and phosphorous analogs thereof, and combinations thereof. Preferably, the first group 501 is capable of forming a chemical bond with one or more of the surface groups 311. More preferably, the first group 501 is capable of forming a covalent bond.

While not wanting to be bound by any theory, non-limiting examples of preferred first group 501 and surface group 311 combinations are carboxylic acids (or carboxylic acid derivatives)/amines (or any primary or secondary nitrogens) or alcohols, thiols/metals (or metal alloys), silanes/hydroxyls, vinyls/vinyls, epoxies/nucleophiles, aldehyde/alcohols or amides or amines, maleimide/thiols, alkynes/azides, and isocyanates/alcohols or amides or amines.

In a preferred embodiment, the group 501 is one of a phosphate ester or silanes. More preferred are silanes having the general formula (RO)₃Si—, comprising a hydrolysable alkyoxy group (RO—), such as, but not limited to: methoxy, ethoxy, and acetoxy.

In another preferred embodiment, the group 501 is a thiol.

The second group 505 is any organic or inorganic group, including without limitation amines, thiols, disulfides, amides, carboxylic acids, acid chlorides, phosphates, phosphate esters, alklenes, alkynes, epoxies (or oxiranes), aldehydes, maleimides/thiols, isocyanates, halogens, hydroxyls, esters, alcohols, their sulfur, phosphate and nitrogen analogs, and combinations thereof. In a preferred aspect, the second group 505 is an amine, epoxy, aldehyde, maleimides thiols, isocyanates , imidazoles or vinyls.

The radical group 503 is an organic radical preferably selected from the group consisting essentially of:
(a.) a C₁ to C₂₅ straight-chain aliphatic hydrocarbon radical,
(b.) a C₁ to C₂₅ branched aliphatic hydrocarbon radical,
(c.) a C₅ to C₃₀ cyclo-aliphatic hydrocarbon radical,
(d.) a C₅ to C₃₀ aromatic hydrocarbon radical,
(e.) a polyether of the type —O—(R¹—O—)ₙ—R² or block or random type —O—(—R¹—O—)ₙ—(R^{1′}—O—)ₘ—R², where
   i. R¹ is a linear or branched hydrocarbon radical having from 2 to 4 carbon atoms,
   ii. R^{1′} is a linear or branched hydrocarbon radical having from 2 to 4 carbon atoms,
   iii. n is from 1 to 40, and
   iv. R² is hydrogen, or a C₅ to C₃₀ straight-chain or branched hydrocarbon radical, or a C₆ to C₃₀ cyclo-aliphatic hydrocarbon radical, or a C₆ to C₃₀ aromatic hydrocarbon radical, or a C₇ to C₄₀ alkylaryl radical,
(f.) a polyether of the type —O—(R¹—O—)ₙ—C(O)—R² or block or random type —O—(—R¹—O—)ₙ—(R^{1′}—O—)ₘ—C(O)—R², where
   i. R¹ is a linear or branched hydrocarbon radical having from 2 to 4 carbon atoms,
   ii. R^{1′} is a linear or branched hydrocarbon radical having from 2 to 4 carbon atoms,
   iii. n is from 1 to 40, and
   iv. R² is hydrogen, or a C₅ to C₃₀ straight-chain or branched hydrocarbon radical, or a C₆ to C₃₀ cyclo-aliphatic hydrocarbon radical, or a C₆ to C₃₀ aromatic hydrocarbon radical, or a C₇ to C₄₀ alkylaryl radical,
(g.) a C₇ to C₄₀ allkyaryl radical having interruption by one or more heteroatoms, such as, oxygen, nitrogen, sulfur, or halide, and
(h.) a C₂ to C₂₅ linear or branched aliphatic hydrocarbon radical having interruption by one or more heteroatoms, such as, oxygen, nitrogen, sulfur, or halide.

In step 243, the first substance 500 is contacted and chemically reacted (and/or interacted) with the modified substrate 301, immobilizing the first substance 500 to the modified substrate 301, forming a first intermediate 245. Preferably, the first group 501 chemically reacts (and/or chemically interacts) with one of more of the surface groups 311, chemically transforming the first group 501 to the third group 515. Or stated another way, the radical group 503 is covalently bonded to the second 505 and third 515 groups, and the third group 515 is covalently bonded to the modified substrate 301. Preferably, the third group 515 comprises, in part, one of a —S—, —S—O—, —N—, —N—O— —Si—, —Si—O—, —P—, —P—O—, —B—, —B—O—, —C—, —C—O, —C—S—, —C—P, —C—N, and combinations thereof.

In a particularly preferred embodiment, the first substance 500 is an epoxy silane having the general formula of

(R¹O)₃Si—R—(C(O)CH₂) (2)

where the radical group 503 is the organic radical as described above, the first group 501 is (R¹O)₃Si—, where R¹ is a C₁ to C₁₂ linear, branched or cyclic alkyl group, and the second group 505 is

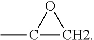

Non-limiting examples of the first substance 500 are β(3,4 epoxycyclohexyl)-ethyltrimethoxysilane, γ-glycidoxypropyl-(trimethoxysilane), and γ-glycidoxypropyl-trimethoxysilane.

In a particularly preferred aspect, the first substance 500 is an epoxy silane of formula (2) and the third group 515 comprises, in part, a —Si— and/or —Si—O— covalent bond between the radical group 503 and the modified substrate 301.

In a preferred embodiment, a number of immobilized first substances 511 are covalently bonded to the (clean substrate 235). The immobilized first substances 511 comprise the radical 503 covalently bonded to the second 505 and third 515 groups. In a more preferred embodiment, the first immobilized substances 511 form about a monolayer (or about single molecular layer) on the substrate 235 (or clean substrate 225 or modified substrate 301).

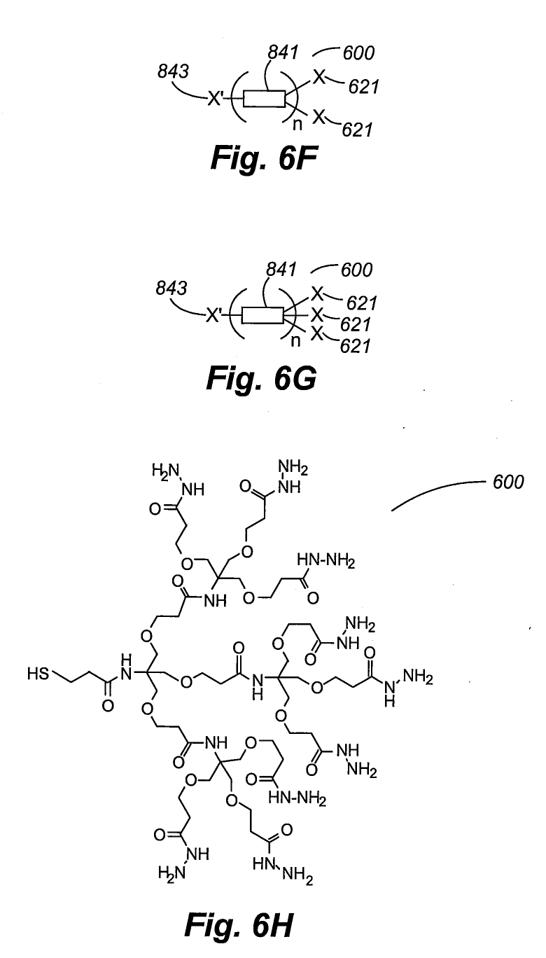

In step 241, a 3-D substance 600 (FIGS. 6A-H) is provided. Preferably, the 3-D substance 600 has at least three surface groups 621. In one configuration, the number of surface groups 621, r, of the 3-D substance 600 having a general structure depicted in FIG. 6A is r=2^{y+1}, where y=1, 2, . . . , 50. In another configuration, the number of surface groups 621 of the 3-D substance 600 having a general structure depicted in FIG. 6B is r=2+z, where z=1, 2, . . . , 150. And, in yet another configuration the number of surface groups 621 of the 3-D substance 600 depicted in FIG. 6C is r=1+a^{y}, where a=1, 2, . . . , 10 and y=1, 2, . . . , 50.

FIG. 6D depicts an aspect of the 3-D substance 600 having a core 801, a number of branching units 803, and a number of surface groups 621. It can be appreciated that, the core 801 has a number of branches. The number of surface groups 621, r, can be calculated the following formula:

R=(number core branches)·(number monomer unit branches)^{generation number} (3)

where the generation number, typically, but not necessarily, is a half integer ranging from about 0 to about 50.

Table I summarizes the first 10 generations of a preferred 3-D substance 600, a poly(amido amine) (PAMAM) dendrimer having a core of 1,4-diaminobutance and a dendrimer of amino-amine. Particularly preferred poly(amido amine) dendrimers are generation numbers 3, 4, and 5.

TABLE I
Typical properties of poly(amido amine) PAMAM dendrimer

| Generation | Molecular | Measured Diameter | No. Surface |
|---|---|---|---|
| number | Weight | (Å) | Groups |
| 0 | 517 | 15 | 4 |
| 1 | 1,430 | 22 | 8 |
| 2 | 3,256 | 29 | 16 |
| 3 | 6,909 | 36 | 32 |
| 4 | 14,215 | 45 | 64 |
| 5 | 28,826 | 54 | 128 |
| 6 | 58,048 | 67 | 256 |
| 7 | 116,493 | 81 | 512 |
| 8 | 233,383 | 97 | 1024 |
| 9 | 467,162 | 114 | 2048 |
| 10 | 934,720 | 135 | 4096 |

Another preferred 3-D substance 600, is a poly(propyleneimine) dendrimer having a core of 1,4 butanediamine and a dendrimer of 1,3-propanediamine (and/or propyleneimine). Particularly preferred poly(propyleneimine) dendrimers of generations 3, 4, and 5.

FIG. 6E depicts another aspect of the 3-D substance 600. The 3-D substance 600 has a number of surface groups 621 and first 821, second 822, third 823, fourth 824, and fifth 825 hydrocarbon radicals. The first through fifth hydrocarbon radicals 821, 822, 823, 824 and 825 vary separately and independently of one another. The first through fifth hydrocarbon radicals 821, 822, 823, 824 and 825 can be, but are not limited to, alkyl and/or aryl radicals.

The 3-D substance 600 (of FIGS. 6A, 6D-E) is commonly referred to as a starburst conjugate, starburst polymer, or dendrimer. The 3-D substance 600 starburst typically has symmetrically progressing dendritic tiers radially extending from an interior core. Non-limiting examples of the 3-D substance 600 are disclosed in the following U.S. Pat. No. 5,338,532 to Tomalia et al., U.S. Pat. No. 6,312,809 to Crooks et al., U.S. Pat. No. 4,857,599 to Tomalia et al., U.S. Pat. No. 6,570,031 to Becke et al., U.S. Pat. No. 6,545,101 to Agarwal et al, and U.S. Pat. No. 6,228,978 to Agarwal et al. all of which are incorporated herein in their entirety by this reference.

A particularly preferred 3-D substance 600 comprises:

1) a core having one or more of:
1-i) 1,12-diaminododecane,
1-ii) 1,6-diaminohexane,
1-iii) 1,4-diaminobutane,
1-iv) ethylenediamine,
1-v) cystamine,
1-vi) or combinations thereof;

2) a dendimer having one or more of:
2-i) 3-caromethoxypyrrolidinone dendrimer,
2-ii) C₁₂ dendrimer dendrimer,
2-iii) amindoethanoldendrimer,
2-iv) propyleneimine dendrimer,
2-v) 1,3-propane diamine dendrimer,
2-vi) aminoethanolamine dendrimer,
2-vii) hexylamide dendrimer,
2-viii) PAMAM OH— dendrimer,
2-ix) PAMAM dendrimer,
2-x) PAMAM OS— dendrimer,
2-xi) OS-trimethoxysilyl dendrimer,
2-xii) sodium carboxylate dendrimer,
2-xiii) succinamic acid dendrimer,
2-xiv) tris(hydroxymethyl)amidomethane dendrimer, and
2-xv) or any combination thereof; and

3) at least three surface groups 621.

Preferred, surface groups 621 are one or more of amines, amides, thiols, silanes, disulfides, phosphates, hydroxyls, esters, carboxylic acids, phosphate esters, epoxies, aldehydes, vinyls, amono-oxies, hydrazides, glycosyl hydrazides, cysteines, glutamics, diazirines, and combinations thereof. More preferred are vinyls, amines, amides, and hydroxyls. Yet even more preferred surface groups 621 are primary and secondary amines.

Other aspects of the 3-D substance 600 are depicted in FIGS. 6F and 6G. In these aspects, the 3-D substance 600 has a core radical 841, a focal group 843, and number of surface groups 621. The focal group 843 and surface groups 621 can, in some instances, comprise substantially identical chemical functionalities. Or stated another way, the focal group 843 can comprise substantially the same chemistry as the above-disclosed number of surface groups 621. The core radical 841 is preferably an organic radical, more preferably a hydrocarbon radical, such as, but not limited to alkyl and/or aryl radicals having branching groups. The core radical 841 alkyl and/or aryl groups and/or their branches can include other organic functional groups, including, but not limited to, amines, ethers, ketones, esters, amides, and anhydrides, hydroxyls, including the heteroatom analogs thereof, and combinations of thereof.

Another preferred configuration of the 3-D substance 600 is depicted in FIG. 6H. The 3-D substance 600 of FIG. 6H is particularly preferred when the surface groups 311 comprise a metal or metal alloy, such as, but not limited to silver, gold, aluminum, and titanium.

A 3-D substance dendrimer means any of the 3-D substance depicted in FIGS. 6A-H having two or more surface groups 621.

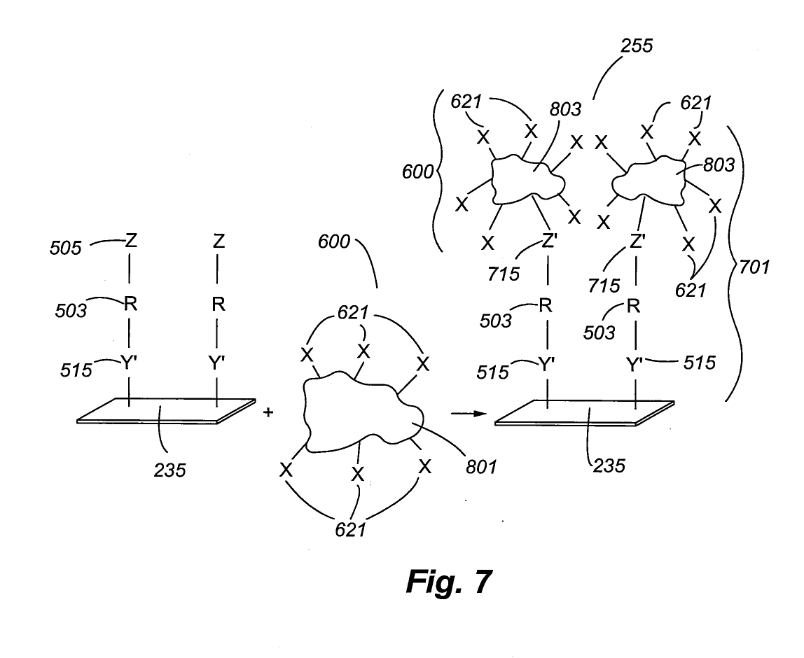

In step 251, a second intermediate 255 is formed (FIG. 7). The surface groups 621 chemically interact with the second group 505 forming a linkage Z′ 715 and a 3-D intermediate 701 immobilized on the substrate 235 (or clean substrate 225 or modified substrate 301). The 3-D intermediate 701 comprises the third group 515, the radical 503, the linkage Z′ 715, and the 3-D substance 600. The linkage Z′ 715 is a reaction product of the second group 505 with one of the surface groups 621. Or, stated another way, the second group 505 and one (or more) of surface groups 621 are converted at least, in part, if not mostly, into the linkage Z′ 715. In a preferred configuration, the linkage Z′ 715 is a covalent bond.

While not wanting to be bound by any theory, non-limiting examples of preferred second group 505 and surface groups 621 combinations are carboxylic acids (or carboxylic acid derivatives)/amines (or any primary or secondary nitrogens) or alcohols, thiols/metals (or metal alloys), silanes/hydroxyls, vinyls/vinyls, epoxies/nucleophiles, aldehydes/alcohols or amides or amines, maleimide/thiols, alkynes/azides, and isocyanates/alcohols or amides or amines.

It can be appreciated that the 3-D intermediates 701 are immobilized forming a layer comprising the 3-D intermediates 701 on the substrate 235 (or clean substrate 225 or modified substrate 301). The layer is at least a mono-layer. That is, the layer is about a single layer or multiple layers of the immobilized 3-D intermediate 701. Preferably, the layer is a single layer of the immobilized 3-D intermediate 701. More particularly Preferred, the layer thickness ranges from about 1 nm to about 20 nm, more preferably from about 1.5 nm to about 13.5 nm.

In one configuration, the surface groups 311 can directly reaction with the surface groups 621 to form a covalent bond. For example, imidazole surface groups 311 can react with amine surface groups 621 to covalently bind the 3-D substance 600 to modified substrate 301 (or substrate 235 or clean substrate 225). In another configuration, the surface groups 621 can chemically interact with the modified substrate 301. A non-limiting example is when the 3-D substance 600 has silane dendritre groups 621. The silane surface groups form covalent bonds with the modified substrate surface 301 and a monolayer of 3-D substance 600 on the substrate 235.

It can be appreciated that the 3-D substance 600 forms a covalent bond to the substrate 235 through a chemical reaction of one or more of surface groups 621 with one of the substrate 235 (or clean substrate 225 or modified substrate 301) or the immobilized first substance 511. Or, stated another way, the 3-D substance can covalently bond with the substrate 235 through the reaction the surface groups 621 directly with the substrate 235, or indirectly, through the reaction with the immobilized first substance 511.

While not wanting to be bound by any theory, the stereochemistry and stoichiometry of the 3-D substance 600 restricts the number of surface groups 621 that can form the linkages 715 and/or a number of links 715. Preferably, the number of surface groups 621 per each molecule of the 3-D substance 600 forming linkages 715 ranges from about 1 to about 25, more preferably from about 1 to about 5. Even more preferably, the number of surface groups 621 per each molecule of the 3-D substance 600 forming the linkage 715 (or number thereof) ranges from about 1 to about 3. Or, stated another way, most, if not all, of the dendrimer functional groups 621 do not react with the second functional group 505.

In a particularly preferred configuration, the first substance 500 is an epoxy silane of formula (2), the surface groups 621 are primary amines, and the second group 505 is an epoxy (or oxirane). The linkage 715 comprises, in part, a —C—N— covalent bond formed by the chemical reaction of the primary amine (of one of the surface groups 621) with the epoxy (of the second group 505). More specifically, the covalent bond linkage 715 comprises a —C(OH)H—CH₂—NH— linkage.

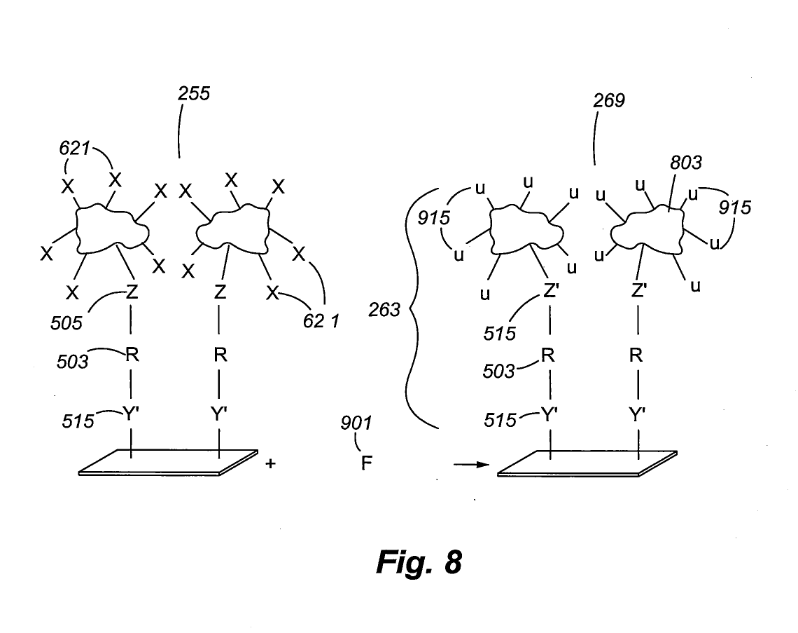

In step 265, the array substrate 269 is formed when at least some of the surface groups 621 remaining after the formation of the linkage 715 undergo a chemical transformation to form a derivatized 3-D substance 263 having a number of derivatized groups 915 (FIG. 8). Step 265 can be a transformation induced chemically, thermally, photochemically, radiochemically, or catalytically. For example, the transformation can be a molecular rearrangement of the surface groups 621 to derivatized groups 915.

In a preferred configuration, a first chemical (or chemicals) 901 is contacted with at least some, or more preferably, at least most, of the number of surface groups 621 forming the derivatized groups 915. In a more preferred configuration, the first chemical (or chemicals) 901 chemically reacts with most, if not all, of the surface groups 621, chemically converting most, if not all, of the surface groups 621 into the derivatized groups 915.

In a particularly preferred configuration, the transformational chemicals 901 comprise one or more of:
a) of Boc-amino-oxyacetic acid, 1-ethyl-3-(3-dimethylaminopropylcarbodimide), and N-hydroxy-succinimide;
b) N,N-dimethylformaide (DMF) solution substantially saturated with succinic anhydride; N-hydroxysuccinimide, and adipic acid dihydrazide
c) tert-butoxycarbonyl-glutamic acid 5-tert-butyl ester, (benzotriazol-1-yloxy)tripyrrolidinophosphonium hexafluorophosphate, 1-hydroxybenzotriazole, and diisopropylethylamine; or
d) N-(tert-Butoxycarbonyl)-S-trityl-L-cysteine, (benzotriazol-1-yloxy)tripyrrolidinophosphonium hexafluorophosphate, 1-hydroxybenzotriazole, and diisopropylethylamine.

These first chemicals 901 form derivatized groups 915 comprising, respectively and in part, one of: a) amino-oxy, b) hydrazide, c) glutamic acid, d) cysteine , e) amino, f) glycosyl hydrazide, g) diazirine, and combinations thereof.

Preferred derivatized groups 915 chemically interact with a carbohydrate. More preferred derivatized groups 915 covalently bond with the carbohydrate through the reducing end of carbohydrates and/or substantially maintain the carbohydrate ring structure when covalently bonded to the carbohydrate. Non-limiting examples, of the more preferred derivatized groups 915 are amines, (—NH₂), amino-oxy (or amino-oxies) (—O—NH₂), hydrazides (—C(═O)—NH—NH₂), glycosyl hydrazides, cysteines (—S—CH₂—CH(NH₂)—C(═O)OH or —C(═O)—CH(NH₂)—CH₂SH), glutamics (—C(═O)—(CH₂)₃—CH(NH₂)—CO₂H or—C(═O) CH(NH₂)—(CH₂)₃—CO₂H), and diazirines (—C(—N₂)H₂).

It can be appreciated that, if the surface groups 621 are chemically equivalent to one of the derivatized groups 915, step 265 can be optional. It can also be appreciated that, the derivatized 3-D substance 263 can include chemical entities of the surface groups 621, as for example, when the transformational first chemical 901 is glutamic acid containing chemical (such as tert butozycarbonyl-glutamic acide 5-tert-butyl ester) and the surface groups 621 are amines the derivatized groups 915 comprise —NH—C(═O)—(CH₂)₃—CH(NH₂)—CO₂H.

Preferably, about 25% or more of the surface groups 621 remaining after the formation of the linkage 715 are transformed to the derivatized groups 915, more preferably about 50% or more, and even more preferably about 90% or more are transformed to the derivatized groups 915.

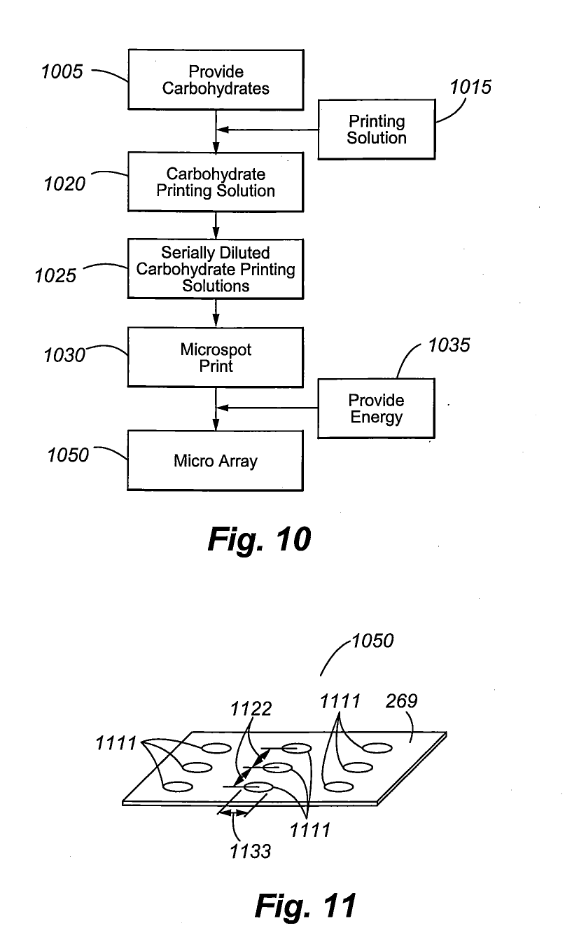

FIG. 10 depicts a process for fabricating a microarray 1050 from the array substrate 269.

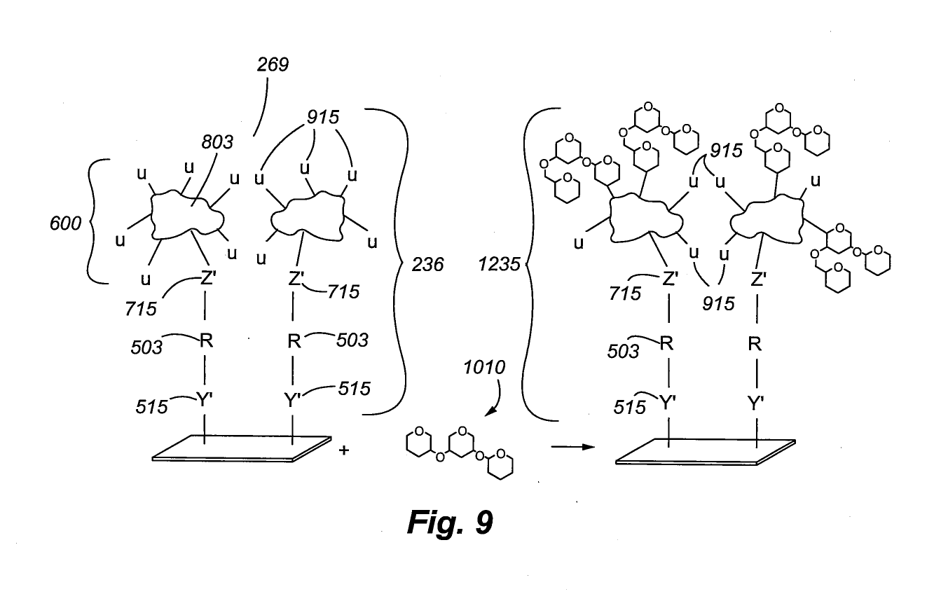

In step 1005, one or more modified or unmodified carbohydrates 1010 (FIG. 9) are selected. The carbohydrates 1010 are selected based on their ability or inability to interact with one or more biological-materials. The other biological-materials can be, but are not limited to, other carbohydrates, nucleic acids, lipids proteins, viral, bacterial, protozoan, fungal pathogens and such. Non-limiting examples of the interactions that can be studied are cell differentiation, cell adhesion, immune response, trafficking, tumor cell metastasis, and carbohydrate interactions with carbohydrates, proteins, lipids, DNA, and/or nucleic acids.

The preferred carbohydrates 1010 can be any carbohydrate based material naturally, chemically, or enzymatically prepared, more preferred are monosaccarides, disaccharides, oligo-saccharides, polysaccharides, glycan-peptides and glyco-proteins.

Preferred monosacchardies include without limitation simple monosaccharides, monosaccharide sulphates, sulphur containing monosaccharides, nitrogen containing monosaccharides, and chlorinated monosacchrides. More preferred monosaccharides are threose, arabinose, lyxose, ribose, xylose, ribulose, xylulose, allose, altrose, galactose, glucose, mannose, talose, fucose, fructose, psicose, sorbose, tagatose, mannoheptulose, sedoheptulose, 2-keto-3-deoxy-manno-octanote, N-acetyl-D-gluosamine (GlcNAc), galactose, N-acetyl-galactosamine (GalNAc), Mannose, N-Acetyl-D-mannosamine, Rhamnose monohydrate, Hamamelose, Fucose, Xylose, Talose, Lyxose, D-Glucosamine-2-N-sulphate, N-Glycolylneuraminic Acid, N-Acetylneuraminic Acid (Sialic Acid), and any chemical modification thereof.

The preferred disaccharides include without limitation sucrose, lactose, maltose, trehalose, cellobiose, gentiobiose, kojibiose, isomaltose, laminaribiose, melibiose, nigerose, rutinose, xylobiiose, Maltose (4-O-α-D-Glucopyranosyl-D-glucose; Maltobiose), D-(+)-Cellobiose Lactose (β-D-Gal-(1→4)-α-D-Glc), 2α-Mannobiose (α-D-Man-[1→2]-D-Man; N,N′-Diacetylchitobiose, 6α-Mannobiose; (α-D-Man-(1→6)-D-Man), Sucrose (α-D-Glc-(1→2)-β-D-Fru; α-D-Glucopyranosyl β-D-fructofuranoside; β-D-Fructofuranosyl-α-D-glucopyranoside; D(+)-Saccharose), Galβ1,4GlcNac(LacNAc) and any chemical modification thereof.

Non-limiting examples of preferred poly- and oligosaccharides are N-Acetyllactosamine and Analogues, Oligomannose Core Structures, N-Acetylglucosamine Core Structures, Lactose Family, Lacto-N-tetraose Family, Lacto-N-neotetraose Family, Lacto-N-hexaose Family, Lacto-N-neohexaose Family, para-Lacto-N-hexaose Family, para-Lacto-N-neohexaose Family, Lacto-N-octaose Family, Blood Group Oligosaccharides and Analogues (Lewis Antigens), Blood Group Oligosaccharides and Analogues (Blood Group A Series), Blood Group Oligosaccharides and Analogues (Blood Group B Series), Blood Group Oligosaccharides and Analogues (Blood Group H (O) Series), Tumour Antigens and Oligosccharides, Galα1-3 Gal series, Cell Adhesion Oligosaccharides, Sialylated Oligosaccharides, High Mannose Type N-Glycans, Xylose Containing Plant N-Glycans, Complex Type N-Glycans, Human IgG N-Glycan Library, Amino-Functionalized Oligosaccharides, Neutral and Sulphated Galacto-Oligosaccharides, Glycosaminoglycan Derived Disaccharides, Oligosaccharides for Plant Biochemistry And Glycobiology, Disaccharide and Trisaccharide Antigens, Heparin Derived Unsaturated Oligosaccharides obtained by Enzyme Cleavage, Miscellaneous Disaccharides, Miscellaneous Trisaccharides, Maltooligosaccharides, Maltooligosaccharide, Maltooligosaccharide Fractions, Cello and Xylooligosaccharides, Acidic Polysaccharides, Neutral Polysaccharides. More specifically, non-limiting examples of preferred poly- and oligosaccharides include starches, glycogen, cellulose, callose, laminarin, xylan, mannan, fucoidan, galactonannan, acidic polysaccharides containing carboxyl, phosphate and/or sulfuric ester groups, and fructo-, glacto-, mannan-oligosaccharides, Maltotetraose (Glcα1-4Glcα1-4Glcα1-4Glc), Maltopentaose (Glcα1-4Glcα1-4Glcα1-4Glcα1-4Glc), Maltohexaose (Glcα1-4Glcα1-4Glcα1-4Glc), Oligomannose-1 (MAN-1)(Manβ1-4GlcNAcβ1-4GlcNAc), Fucα1,6Manβ1-4GlcNAcβ1-4GlcNAc, Manβ1-4GlcNAcβ1-4GlcNAc, Manα1,3Manβ1-4GlcNAcβ1-4GlcNac, Manα1,6Manα1,3Manβ1-4GlcNAcβ1-4GlcNAc, Manα1,3Manα1,6Manβ1-4GlcNAcβ1-4GlcNAc, Manα1Manα1Manβ1-4GlcNAcβ1-4GlcNAcFucα1, NeuAcα-3Galβ-4Glc, Neu5Acα2-3Galβ1-4Glc, NeuAcα-6Galβ-4Glc, NeuAcβ-3Galβ-4Glc, NeuAcβ-6Galβ-4Glc, Neuα-3Galβ-4Glc, 3-α-Galactobiose (α-D-Gal-(1→3)-D-Gal); galacto-N-bioside (Gal-β1,3-GalNAc), 3α,4β,3α-Galactotetraose (α-D-Gal-(1→3)-β-D-Gal-(1→4)-α-D-Gal-(1→3)-D-Gal), Fucα1-2 Gal, Galα1-4GlcNAc(LacNAc), 2′-Fucosyl-D-lactose (α-L-Fuc-(1→2)-β-D-Gal-(1→4)-D-Glc)β-D-Gal-(1→4)-β-D-GlcNAc-(1→3)-β-D-Gal-(1→4)-D-Glc (Lacto-N-neo-tetraos), LS-Tetrasaccharide b(α-NeuNAc-(2→6)-(β-D-Gal-[1→3])-β-D-GlcNAc-(1→3)-β-D-Gal-(1→4)-Glc), α-GalNAc-(1→3)-(≢-Fuc-[1→2])-β-Gal-(1→3)-(α-Fuc-[1→4])-Glc (iso-A-Pentasaccharide), α-L-Fuc-(1→2)-β-D-Gal-(1→4)-D-Glc (2′-Fucosyl-D-lactose), α-Fuc(1→2)-β-Gal-(1→3)-(α-Fuc-[1→4])-GlcNAc (Le^{b} glycan), α-Fuc-(1→2)-β-Gal-(1→4)-(α-Fuc-[1→3])-GlcNAc (Le^{y} glycan), Galβb1-4(Fucα1-3) GlcNAc (Lewis^{x} trisaccharide), α-NeuNAc-(2→3)-β-D-Gal-(1→3)-(α-L-Fuc-[1→4])-D-GlcNAc (Sialyl Le^{a}), SO₃-3Galβ1-3GlcNAc (Sulpho Lewis^{a}), Galβ1-3(Fucα1-4)GlcNAc (Lewis^{a} trisaccharide), 3′-N-Acetylneuraminyl-N-acetyllactosamine sodium(α-NeuNAc-(2→3)-β-D-Gal-(1→4)-D-GlcNAc), α-NeuNAc-(2→6)-β-D-Gal-(1→4)-D-Glc (6′-N-Acetylneuraminyl-lactose sodium salt), α-NeuNAc-(2→3)-β-D-Gal-(1→4)-D-Glc, (3′-N-Acetylneuraminyl-D-lactose sodium salt; 3′-Sialyl-D-lactose, Galα-1-4Galβ1-4Glc, GlcNAcβ1-4GlcNAcβ1-4GlcNAc (N,N′,N″-Triacetyl chitotriose), α-D-Gal-(1→4)-β-D-Gal-(1→4)-D-Glc (Globotriose), β-D-Gal-(1→3)-β-D-GIcNAc-(1→3)-β-D-Gal-(1→4)-D-Glc(Lacto-N-tetraose)

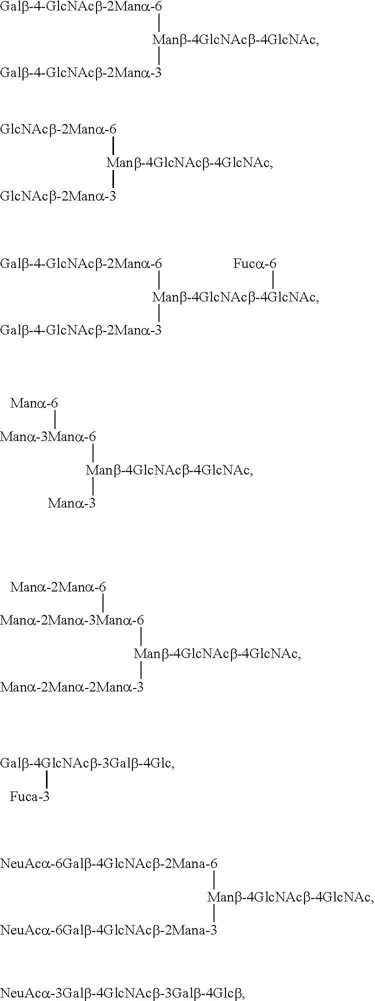

Mannan from Saccharomyces cerevisiae, Xylan, Amylose, Chitosan, Curdlan, Dextran, Guar gum obtained from the seed of the legume Cyamopsis tetragonolobus, Chitin, Scleroglucan produced by the fermentation of the fungus Sclerotium rolfsii, Pullulan from the fungus Aureobasidium pullulans, Larch arabinogalactan extracted from the heartwood of the western larch Larix occidentalis, Inulin, Agar, Alginic acid, Propylene Glycol Alginate, Gum Arabic, Glcβ-(3Glcβ)9-3Glc, Glcβ-(3Glcβ)5-3Glc, Glcβ-(6Glcβ)5-6Glc and any chemical modification thereof.

Non-limiting examples of preferred glycoproteins include Blood Group and Lewis Antigen Neoglycoconjugates, Core Structured Neoglycoproteins, Tumour Antigen Neoglycoproteins, Monosaccharide Neoglycoproteins, Sialylated Neoglycoproteins, Galα1-3-Gal Series Neoglycoproteins, Galα1-3-Gal Analogue Neoglycoproteins, Neoglycolipids, Blood Group A-BSA, Lacto-N-fucopentaose I-BSA Lacto-N-difucohexaose I-BSA, Blood Group B-BSA, Globotriose-HAS, Lewis^{x}-BSA, 2′Fucosyllactose-BSA (2′FL-BSA), T-Antigen-HSA (Galβ1-3GalNAc-HSA), Tn-Antigen-HAS (GalNAca1-0-(Ser-N-Ac-CO)-Spacer-NH-HAS), N-Acetyllactosamine-BSA, N-Acetyllactosamine-BSA, a1-3,a1-6-Mannotriose-BSA; 3′-Sialyl-N-Acetyllactosamine-BSA, 3′-Sialyl-3-fucosyllactose-BSA, 3′-Sialyl Lewis^{x}, Galα1-3Gal-BSA, Galα1-3Gal-HAS, and Galα1-3Galβ1-4GlcNAc-BSA, Galα1-3Galβ1-4GlcNac-HAS.

A carbohydrate printing solution 1020 is prepared by dissolving one the carbohydrates 1010 in a printing solution 1015. The printing solution 1015 is any solution capable of solublizing or dissolving the carbohydrates 1010 and not interfering with the fabrication and/or assay glycomic analysis of the microarray 1050. Preferred printing solutions 1015 comprise one of a:
1) sodium phosphate buffer having a pH of about pH 5.0 containing about 30 wt % glycerol;
2) a DMSO/H₂O (about 1:1) solution;
3) a Formamide/H₂O (about 1:1) solution;.
4) a 0.1 mM sodium phosphate buffer having a pH of about pH 5.0;
5) a 0.1 mM sodium phosphate buffer having a pH of about pH 7.4; or
6) 0.1 mM sodium citrate buffer having a pH of about pH 6.0
7) an aqueous solution containing about 1 wt % NaCl and about 25 wt % acetontirile.

Preferably, the carbohydrate printing solution 1020 comprises from about 0.01 wt % to about 1×10⁻⁷ wt % carbohydrate 1010, more preferably from about 0.001wt % to about 1×10⁻⁵ wt % carbohydrate. Or stated in another way, the carbohydrate printing solution 1020 has carbohydrate concentration (wt/v) from about 10 mg/mL to about 0.001 ug/mL carbohydrate 1010, more preferably from about 1 mg/mL to about 0.1 ug/mL.

The (base) carbohydrate printing solution 1020 can be further diluted with the printing solution 1015 to form a number of serially diluted carbohydrate printing solutions 1025 at a various different dilution levels. Preferably, three serially diluted printing solutions 1025 are prepared at dilution levels 1:4, 1:16, and 1:64 with respect to the (base) carbohydrate printing solution 1020.

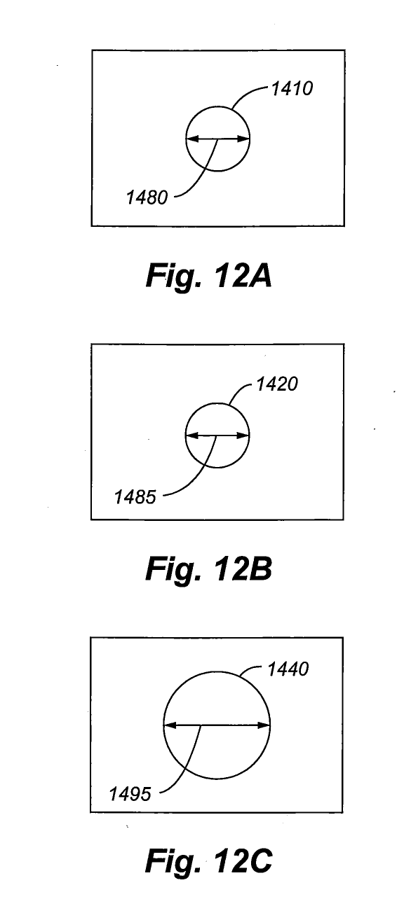

In step 1030, each of the carbohydrate printing solutions 1025 are microspot printed, at least in triplicate on the array substrate 269, forming a number of microspots 1111 (FIG. 11). The microspot printing process can be manually, mechanically, or robotically printed, preferably from a 94-well plate, 196-well plate, and 384-well plate. Although any robotic printer may be employed, a Biopak™ robotic printer is an example of a suitable microspot printer. The microspots 1111 are essentially circular, with each microspot 1111 having a diameter 1133 preferably ranging in size from about 1 um to about 1 mm, and even more preferably from about 50 um to about 500 um. The microspots 1111 are separated, by a distance 1122, measured between adjacent microspot centers, the distance 1122 preferably ranges from about 50 μm to about 1000 μm, more preferably from about 100 μm to about 500 um, and even more preferably from about 150 μm to about 250 μm. Each microspot 1111 preferably has from about 0.1 nL to about 1 uL carbohydrate 1010 and more preferably from about 1 nL to about 10 nL of one of the carbohydrates 1010. Or stated another way, the preferred number of weight of one of the carbohydrate 1010 in each microspot 1111 ranges from about 10 ng to about 0.01 fetmo gram.

It can be appreciated that the printing of the microspots 1111, in step 1030, includes a contacting of the carbohydrates 1010 (FIG. 9) with one of the derivatized groups 915. Preferably, the carbohydrate 1010 and at least one of the derivatized groups 915 chemically react, forming a covalent bond between the one of the carbohydrate 1010 and the derivatized groups 915 on the 3-D substance 263 forming an immobilized carbohydrate 1235. Preferably, the derivatized groups 915 are one or more of an aminooxy, hydrazide, glutamic and/or cysteine groups, and the covalent bond between the carbohydrate 1010 and the derivatized groups 915 that are on the derivatized 3-D substance 263 respectively comprises one of amide, oxime, glycosyl, thiazolidine, or similar chemical bonding linkage.

These covalent bonds are preferred for their chemical stability and substantially retaining at least most, if not all, of the carbohydrate ring structure. The response of immobilized carbohydrate 1235 for protein interactions in a glycomic assay is believed to be more reliable and representative when the carbohydrate ring is maintained in the microarray 1050.

It can be appreciated that, maintaining carbohydrate ring structure of the immobilized carbohydrate is preferable, especially for monosaccharides having a single ring, as the ring structure enhances probing carbohydrate interactions with a protein, such as, in carbohydrate protein interaction. Or stated another way, maintaining the carbohydrate ring structure is preferable for preserving the biological function of the carbohydrate. Or stated in yet another way, for the immobilized carbohydrate 1235 to properly represent the biological function of the non-immobilized carbohydrate 1010 the ring structure of the immobilized carbohydrate 1235 should be substantially maintained.

When the ring structure of the immobilized carbohydrate has not been substantially maintained, the ring structure typically can be restored by a reducing agent. Preferred reducing agents are sodium borohydride (NaBH₄), Na₂BO₃, lithium aluminum hydride (LiAlH₄), diboran (BH₃), and 9-borabicyclo[3.3.1]nonane (9-BBN). More preferred reducing agents are NaBH4, and LiAlH_{4.}

In one preferred configuration, more than one carbohydrate 1010 contacts the derivatized 3-D substance 263 and chemically reacts with more than one of the derivatized groups 915 forming one or more immobilized carbohydrates 1235 per derivatized 3-D substance 263. The preferred number of carbohydrates 1010 covalently bonded to a single derivatized 3-D substance 263 ranges from about 1 to about 12, more preferred ranges about 1 to about 5 and even more preferably, from about 1 to about 3.

Preferably, about 50% or more, more preferably at least about 75%, and even preferably at least about 95% of the derivatized 3-D substances 263 within a single microspot 111 have at least one covalently bonded carbohydrate 1010 immobilized thereto.

While not wanting to be bond by any theory, the greater the concentration of covalently bonded carbohydrates 1010 per microspot 1111 the greater the response and sensitivity of the microarray 1050 in a glycomic assay. The concentration of covalently bonded carbohydrates 1010 is proportionally related to the number of covalently bonded carbohydrates 1010 per derivatized 3-D substance 263 and/or the percentage of derivatized 3-D substances 263 having at least one covalently bonded printed carbohydrate 1010.

In step 1035, energy is provided to accelerate the covalent bond formation, that is, the reaction of carbohydrate 1010 with the derivatized groups 915, to form the microarray 1050. The covalent bonding of the carbohydrate 1010 with derivatized groups 915 is typically kinetically slow, in the absence of thermal energy. Thermal energy can be provided as radiant thermal or electromagnetic energy. Electromagnetic energy is preferred for its efficiency and speed of covalent bond formation, increasing the reaction kinetics. Preferred electromagnetic energy ranges from about 124 eV(or about 10 nm or about 30 PHz) to about 124 neV (or about 1 dam or about 30 MHz). More preferably,the electromagnetic (or microwave) energy ranges from about 1.24 meV (or about 1 mm or about 300 GHz) to about 1.24 μeV (or about 1 m or about 300 MHz).

It can be appreciated that microwave exposure time, energy, and/or power can vary depending on the carbohydrate immobilization chemistry; that is, these parameters depend upon the specific carbohydrate(s) 1010 and the derivatized group(s) 915 involved. The microwave energy is preferably supplied by a microwave oven having a power output ranging from about 300 to 3,000 watts. Preferred microwave exposure periods range from about 1 minutes to about 30 minutes and even more preferably from about 5 minutes to about 15 minutes. Preferred microwave energy ranges from about 0.3 GHz to about 300 GHz and even more preferably from about 10 GHz to about 100GHz. Preferred power levels range from about 200 watts to about 3000 watts and even more preferably from about 600 watts to about 2000 watts. Preferred microwave power levels range from about 25% to about 100%. In one example, the preferred exposure period ranges from about 1 minute to about 30 minutes and even more preferably from about 5 to about 15 minutes for a 2.45 GHz, 800 watt oven operating at 50% power output.

Non-limiting examples of specific exposure times, energies, and power levels for various carbohydrate chemistries are given in Table II.

TABLE II

| | Derivatized | Microwave | Microwave | Power |
|---|---|---|---|---|
| Carbohydrate | Group 915 | time | energy | level |
| glucose | Aminooxy | 8 mins | 2.45 GHz, | 50% |
| | | | 600 watt | |
| Galactose | Hydrazide | 8 mins | 2.45 GHz, | 50% |
| | | | 800 watt | |
| Maltobiose | Hydrazide | 10 mins | 2.45 GHz, | 50% |
| | | | 800 watt | |
| Maltopentaose | Aminooxy | 10 mins | 2.45 GHz, | 50% |
| | | | 800 watt | |
| Sialic acid | Glutamic | 10 mins | 2.45 GHz, | 50% |
| | acid | | 800 watt | |
| Manα1,3Manα1,6 | Cysteine | 10 min | 2.45 GHz, | 50% |
| Manβ1- | | | 800 watt | |
| Mannan from | Hydrazide | 12 mins | 2.45 GHz, | 50% |
| Saccharomyces | | | 800 watt | |
| Dextran 20 Ka | Hydrazide | 15 mins | 2.45 GHz, | 50% |
| | | | 800 watt | |

Using the electromagnetic featured microwave radiation energy to immobilize a carbohydrate to another substance can reduce significantly the time required to immobilize carbohydrates as taught by the prior art radiant thermal immobilization processes while increasing the efficiency and/or efficiency of carbohydrate immobilization. Although examples of the invention are discussed with reference to specific materials and carbohydrates, the carbohydrate microwave immobilization process as disclosed herewith is applicable to the immobilization of any carbohydrate to any substance.

While not wanting to be bound by any theory, microwave energy accelerates covalent bond formation and efficiently leads to a greater number of covalent bonded printed carbohydrates per microspot. It is further believed that the microwaves, lead to a higher concentration of printed carbohydrate 1010 covalently bonded per microspot per unit of concentration of applied carbohydrate 1010 printing solution. That is, when microwave energy is used for forming covalent bonds a greater percentage of the printed carbohydrates 1010 form covalent bonds with the 3-D derivatized substance 263 than when thermal energy is used.

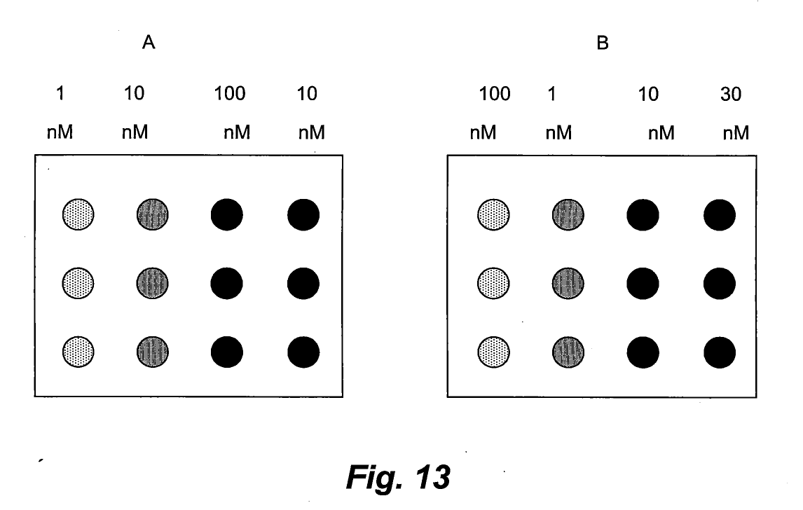

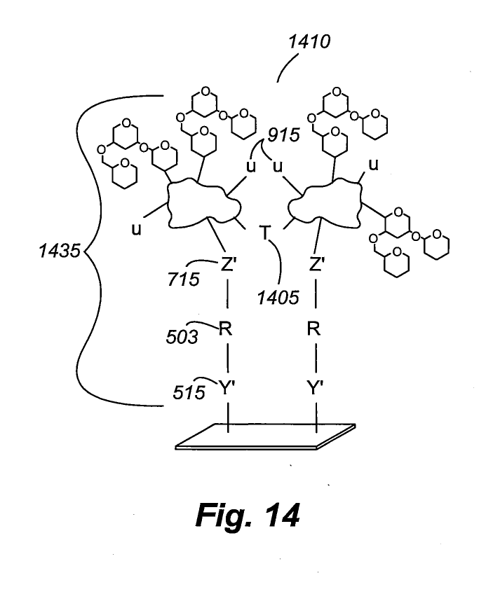

Additionally, microwave energy is preferred for the rapidity of covalent bond formation. FIGS. 12A-C depict the speed with which microwave energy fixes a printed spot 1410 having a printed diameter 1480. While not wanting to be bound by any theory, the effects of surface tension increase the printed diameter 1480 after printing the spot 1410. The glycomic assay response of the printed spot 1410 decreases when the printed diameter 1480 increases due to decreased surface area concentration of the immobilized carbohydrate 1235. Microarray production costs also increase when the printed diameter 1480 increases after printing. For example, a greater amount of the substrate 235 is required for a given number of printed spots 1410 and/or a higher concentration of the carbohydrates 1010 per printed spot 1410 are required for an equivalent glycomic assay response. The more rapidly the carbohydrates 1010 are immobilized the less the spreading of the printed spot 1410. Microwave energy rapidly fixes, or immobilizes, the carbohydrates 1010 within the printed spot 1410, forming a microwave fixed spot 1420 having a microwave fixed diameter 1485. The printed diameter 1480 and microwave fixed 1485 diameters are substantially equal. Thermal energy immobilization does not substantially maintain the printed diameter 1410. A thermally immobilized carbohydrate microspot 1440 has a substantially greater thermal fixed diameter 1495 than the diameter of the printed diameter 1480. While not wanting to be bound by any theory, a longer time is required to immobilize the carbohydrates 1010 by a thermal process than by a microwave process because the thermal process can allow for greater spreading of printed spot 1410. The speed of microwave fixing for the assembly of the microarray 1050 is preferred for the economics and speed of commercial production of carbohydrate microarrays 1050.

In one configuration, carbohydrate microarray 1050 surface is blocked by a typical blocking solution. Non-limiting examples of suitable blocking solutions are Phosphate buffer having 0.5% bovine serum albumin, phosphate buffer having 0.5% casein, Phosphate buffer having 3% fat-free milk, and superblocking reagents from Sigma.

In one preferred configuration, one or more of the microwave exposure time, energy, and power is reduced when the surface groups 311 comprise a metal or metal alloy. In one configuration, the surface groups 311 comprise a mono-layer of a metal or metal alloy comprising one of copper, platinum, palladium, nickel, cobalt, rhodium, iridium, gold, silver, titanium, and aluminum. While not wanting to be bound by any theory, the metal appears to focus the microwave energy at the substrate 235 surface, more rapidly forming covalent bonds, particularly the covalent bond between the carbohydrates 1010 and 3-D derivatized substance 263.

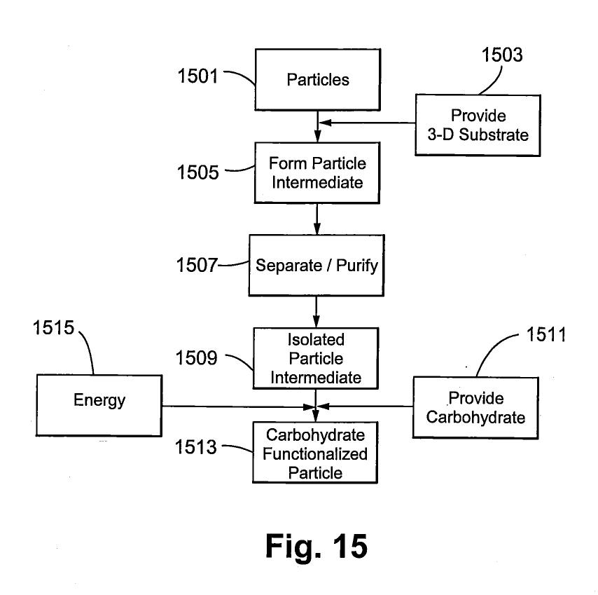

In one configuration, derivatized groups 915 of adjacent immobilized carbohydrates 1235 are contacted and/or chemically reacted with a homobifuctional reagent, ADHZ adipic acid dihydrazide (Sigma) being an exemplary, forming a covalent cross-linkage 1405 (FIG. 14) entity “T”. The covalent cross-link 1405 chemically bonds two adjacent immobilized carbohydrates 1235. It can be appreciated that, most of the immobilized carbohydrates 1235 can be cross-linked to form a mono-layer comprising most of immobilized carbohydrates 1235 covalently joined by a plurality of covalent cross-linkages 1405.

The microarray 1050 is suitable for probing carbohydrate-carbohydrate and carbohydrate-protein interactions. The microarray 1050 is particularly preferred for probing carbohydrate interactions and communications with proteins and/or other carbohydrates concerning genetic, physiological, pathologic, and associated biological aspects. Or stated another way, the immobilized carbohydrate 1235 on the microarray 1050 is preferred for probing the carbohydrate interactions and communications with proteins and/or other carbohydrates concerning genetic, physiological, pathologic, and associated biological aspects. While not wanting to be bound by any theory, the communications, interactions, and associations probed are those between the immobilized carbohydrate 1235 and one or more of peptides, lipids, proteins and those communications, interactions, and associations in the form of one or more of glycopeptides, glycolipids, glycosaminoglycans, and proteoglycans.

It can be appreciated that the glycomic analysis of immobilized carbohydrate communications, interactions, and associations in the form of one or more of glycopeptides, glycolipids, glycosaminoglycans, and proteoglycans can be by one of: raman, infrared, near infrared, visible, or ultra violet spectroscopy; fluorescence; magnetic resonance imaging; electrochemical potentials and/or voltages; and/or chemilluminesance.

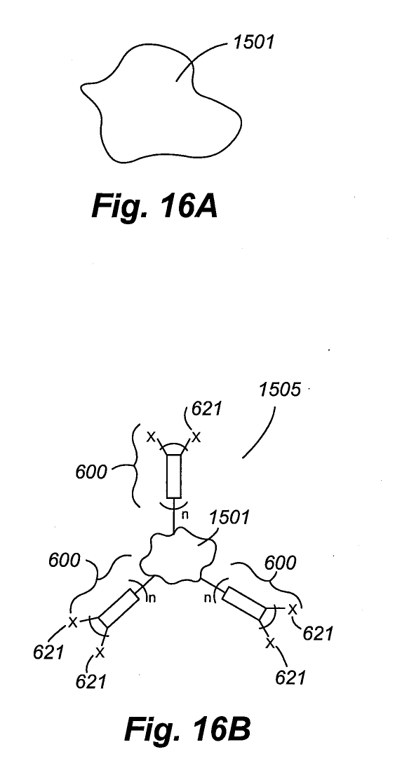

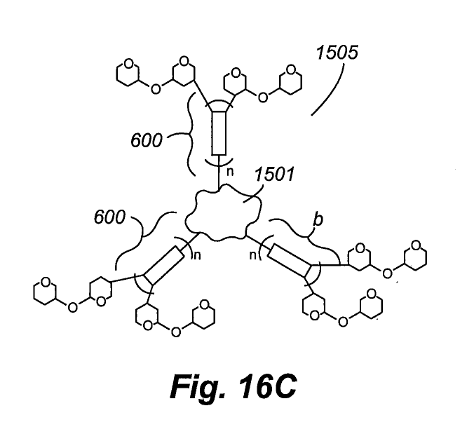

A method of fabricating carbohydrate particles is depicted in FIG. 15. In step 1503, a three-dimensional substance 600 is provided and contacted with a plurality of particles 1501 (FIG. 16A). Preferably, the particles 1501 are metal, semiconductor, polymer, organic or silica. In a preferred embodiment, the particles 1501 are gold or a semiconductor. In one configuration the particles 1501 are (CdSe)ZnS nanoparticles with trioctylphosphine oxide ligands. In another configuration the particles 1501 are citrate-stabilized gold nanoparticles. Preferably, the particle 1501 diameter ranges from about 0.1 nanometers to about 100 micrometers. The particle 1501 three-dimensional geometric shape can be any geometric shape, preferred geometric shapes approximate spherical, cylindrical, or wire-like.

The three-dimensional substance 600 provided is any one of the three-dimensional substances 600 described above. In a preferred embodiment the three-dimensional substance 600 is one of the substances depicted in FIG. 6C, 6F, 6G, or 6H. The surface groups 621 are any of above the above identified dendrite 621 or derivatized 951 group chemistries. The focal group 843 is any of the above identified focal group 843 chemistries.

The focal group 843 is contacted and reacted with the particle 1501 to form the particle intermediate 1505 (FIG. 16B). The reaction of the focal group 843 with the particle 1501 vares according to the chemical reaction between the particles 1501 and the three-dimensional substance 600 and their respective chemistries. Non-limiting examples include an addition reaction (when the particle 1501 is gold and the focal group 843 is thiol) or two-phase exchange reaction (when the particle 1501 is (CdSe)ZnS with trioctylphosphine oxide ligands and the focal group 843 is thiol). Preferably, one or more three-dimensional substances 600 are reacted with the particle 1501. Or stated another way, the particle intermediate 1505 preferably comprises one particle 1501 with a plurality of three-dimensional substances 600 bonded to the particle 1501. Preferably the molar ratio of the three-dimensional substance 600 with the particle 1501 ranges from about 300:1 to about 0.5:1. Preferred, non-limiting examples, of the variability of the molar range are: a) from about 150:1 to about 75:1 for the ratio of the thiol focal group 843 with the gold particle 1501, and b) from about 2:1 to about 0.8:1 for the thiol focal group 842 with the (CdSe)ZnS particle 1501.

In step 1507, the particle intermediate 1505 is separated from unreacted three-dimensional substance 600, any other reactant(s), reaction product(s), and/or solvent(s) and purified to form an isolate particle intermediate 1509. Any suitable separation and/or purification process are suitable. Non-limiting examples include ultracentrifugation (when the particle intermediate 1505 comprises gold), precipitation, crystallization (when the particle intermediate 1505 comprises (CdSe)ZnS).

A carbohydrate functionalized particle 1513 (FIG. 6C) is formed by contacting and/or chemically reacting a carbohydrate 1010 (provided in step 1511) with the isolated particle intermediate 1509 to covalently bond the carbohydrate 1010 to the particle 1505 (or isolated particle intermediate 1509), energy 1515 is provided to accelerate the bond formation process. The carbohydrate 1010 is any of the above identified carbohydrates 1010. The carbohydrate 1010 is typically reacted with the isolated particle intermediate 1509 in one of the above described printing solutions 1015. Preferred pH of the printing solution range from about pH 3 to about pH 9, more preferred range from about pH 5 to about pH 8. The covalent bond is formed, as describe above, by chemically reacting the carbohydrate 1010 with one or more of the denrite 621 (and/or derivatized 951) groups with the carbohydrate 1010. Preferably, the molar ratio of carbohydrate 1010 to the dendrite 621 (or derivatized 951) group ranges from about 2 to about 1, more preferably from about 1.5 to about 1.1. Hydrazide is a preferred surface group 621 for reacting with the carbohydrate 1010.

The energy 1515 is typically applied as thermal or microwave energy to accelerate the covalent bond formation. Microwave energy is preferred for the speed and high level of covalent bond formation. Preferably, one or more carbohydrates 1010 covalently bonded to each of the three-dimensional substances 600 bond to the particle 1501. Preferred microwave energy levels and condition are given above.

The carbohydrate functionalized particles 1513 are typically isolated by centrifugation or gravitation. The isolated functionalized particles 1513 are resuspended in a solution. Preferred solutions for resuspending the functionalize particles 1513 are water or phosphate buffer. More preferred are the phosphate printing solutions 1015 disclosed above and in the Examples below.

The carbohydrate functionalized particles 1513 can be used for any of the above described glycomic analyses. The functionalized particles 1513 are preferred for in-situ carbohydrate-protein interaction studies.

### EXAMPLES

Various aspects of the invention are illustrated below in a number of examples. These examples are presented by way of illustration only and are not intended to limit in any way the invention.

### Example A

### Preparation of a Substrate

A substrate, which can be a silica wafer, glass slide, or quartz, was immersed in a Piranha solution (1 part H₂O₂ to 3 parts H₂SO₄) having a temperature of 70° C. for about 10 minutes, then rinsed first with distilled water, followed by a HPLC purified ethanol.

### Example B

### Silylation of a Substrate

The prepared substrate of Example A was immersed for about 30 minutes in a toluene solution having about 1 mM/L of (3-glycidyloxypropyl) trimethoxysilane (GPTS) at ambient temperature.

### Example C

### Activation of a Substrate With Carbonyldiimidazole

The prepared substrate of Example A was immersed in a dioxane solution of CDI (1,1′-carbonyldiimidazole, 50 mM) for 24 h at room temperature with stirring. At the end of immersion period, the substrate was washed first with ethanol, then with acetone, and dried with a nitrogen stream.

### Example D

### Preparation of a Substrate Having a PAMAM Dendrimer Coated Surface

The silylated substrate of Example B or Carbonyldiimidazole activated substrate of Example C was immersed with gentle agitation in an ambient temperature methanol solution having 0.2 wt % PAMAM dendrimer generation 4 (having 64 surface groups). At the end of immersion period, the substrate was washed first with ethanol, then with acetone, and dried with a nitrogen stream.

### Example E

### Preparation of a Substrate Having a Poly(propyleneimine) Dendrimer Coated Surface

The silylated substrate of Example B or Carbonyldiimidazole activated substrate of Example C immersed over night in a stirred, 0.3 mM solution of poly(propyleneimine) (DAB-Am-64, Aldrich, Milwaukee, Wis.) dendrimer over night with gentle agitation, after which the substrate was washed with ethanol, then acetone, and dried with a nitrogen stream.

### Example F

### Preparation of a Substrate Having a Dendrimer Coating With Outmost Surface Amino-Oxy Groups

The dendrimer treated substrate of Example D or E was immersed for about 2.5 hours in a 50 nM aqueous phosphate buffer solution having a pH of about pH 6.0 containing 1 mM each of Boc-amino-oxyacetic acid, 1-ethyl-3-(3-dimethylaminopropylcarbodimide), and N-hydroxy-succinimide (Sigma-Aldrich, Milwaukee, Wis.) with gentle agitation, then washed with water, and immersed for about 2 hours in a solution having about 1 M each of hydrochloric and acetic acids. Following the acid immersion with gentle agitation, after which the substrate was washed with ethanol, then water, and spun dried.

### Example G

### Preparation of a Substrate Having a Dendrimer Coating With Outmost Surface Hydrazide Groups

The treated substrate of Example D or E was immersed overnight in a N,N-dimethylformaide (DMF) solution substantially saturated with succinic anhydride with stirring. After the immersion, the substrate was washed several times with DMF, immersed for about one hour in a DMF solution containing about 0.01 moles per liter each of N-hydroxysuccinimide and 1-ethyl-3-(3-dimethylaminopropylcarbodimide) for about 1 hour with gentle agitation, and then washed with DMF. After the DMF wash the substrate was immersed for about 2.5 hours in an aqueous solution containing about 10 mg/mL of adipic acid dihydrazide with gentle agitation, washed with water, and dried with a stream of nitrogen.

### Example H

### Another Preparation of a Substrate Having a Dendrimer Coating With Outmost Surface Hydrazide Groups

The treated substrate of Example D or E was immersed overnight in a N,N-dimethylformaide (DMF) solution substantially with 10 % (wt/v) glutaraldehyde. After the immersion, the substrate was washed several times with DMF, immersed for about one hour in a DMSO solution containing about 1 moles per liter of hydrazine with gentle agitation, after which the substrate was washed with water, and dried with a stream of nitrogen.

### Example I

### Preparation of Substrate Having a Dendrimer Coating With Outmost Surface Boc-Gul(O^{t}Bu) Groups

The treated substrate of Example D or E was immersed with stirring for about 1 hour in a DMF solution having 0.32 millimoles of tert-butoxycarbonyl-glutamic acid 5-tert-butyl ester, 0.24 millimoles of (benzotriazol-1-yloxy)tripyrrolidinophosphonium hexafluorophosphate, 0.24 millimoles of 1-hydroxybenzotriazole, and 0.36 millimoles of diisopropylethylamine. After the immersion period, the substrate was washed with DMF (3 times, for 1 minute each time) and CH₂Cl₂ (2 times for 1 minute each, 1 for 5 minutes, and 2 times for 1 minute each).

### Example J

### Preparation of a Substrate Having a Dendrimer Coating With Outmost Surface Glutamic Acid Surface Groups

The substrate of Example I was treated with either with 0.1 M dichloromethane solution of TFA or sequentially with 1 M HCl and saturated NaHCO₃ aqueous solution, after which the substrate was washed with water and dried with a stream of nitrogen.

### Example K

### Preparation of a Substrate Having a Dendrimer Coating With Cysteine Surface Groups

The dendrimer-treated glass/quartz/silica wafer substrate of Example D or E is immersed a DMF solution of Boc-Cys(Trt)-OH (N-(tert-Butoxycarbonyl)-S-trityl-L-cysteine, 0.32 mmol), PyBOP (benzotriazol-1-yloxy)tripyrrolidinophosphonium hexafluorophosphate; 0.24 mmol), HOBt (1-hydroxybenzotriazole, 0.24 mmol), and DIEA (diisopropylethylamine, 0.36 mmol). The solution was stirred for 1 hr at room temperature. The substrate was then washed with DMF (3×1 min) and CH₂Cl₂ (2×1 min, 1×5 min, 2×1 min) and stored wet at 5′ C. Deprotection of Boc and Trt groups was accomplished with TFA-CH₂Cl₂ (1:1) in the presence of Et₃SiH (15 equiv) immediately prior to carbohydrates immobilization.

### Example L

### Miocrospotting of Carbohydrates to Form a Microarray

Each of a number of carbohydrate probes to be printed was dissolved in one of the printing solutions comprising:
1) sodium phosphate buffer having a pH of about pH 5.0 containing about 30 wt % glycerol;
2) a DMSO/H₂O (about 1:1) solution;
3) a Formamide/H₂O (about 1:1) solution;.
4) a 0.1 mM sodium phosphate buffer having a pH of about pH 5.0;
5) a 0.1 mM sodium phosphate buffer having a pH of about pH 7.4; or
6) 0.1 mM sodium citrate buffer having a pH of about pH 6.0
7) an aqueous solution containing about 1 wt % NaCl and about 25 wt % acetontirile.

The carbohydrate concentration in the printing solution ranges from about 1 nM to about 50 mM. Each concentration of each carbohydrate probe was printed at least one times on any one of the prepared substrates of Examples F, G, H, J and K with a distance of about 250 um between the centers of adjacent spots using a robotic printer (MicroGrid TAS™ array printer with a 384-well plate). Each microspot contained about 1 nL of carbohydrate solution. The printing was conducted at a temperature of about 30° C. and a relative humidity of about 60%.

### Example M

### Preparation of a Phosphate Buffer

A phosphate buffer having a pH of about pH 7.4 is prepared by dissolving about 10 milimole of 100 mM sodium phosphate, 0.138 mole of NaCl, 0.0027 mole of KCl and about 1 gram of Tween™ 20 in enough deionized water to prepare about a liter.

### Example N

### Immobilization of Spotted Carbohydrates Using Microwave Energy

The printed carbohydrate microspots of Example L were covalently immobilized using microwave radiation energy supplied by a domestic microwave oven (GE™ or SANYO Turnable microwave oven) having a maximum power level of about 850 watts. The printed carbohydrate microarray substrate was placed in the microwave oven on a plate and subjected to microwave radiation. The microwave power level was about 50% of the maximum 850 watts, the exposure time varied from about 4 to about 15 minutes. After the microwave radiation, the microarray was immersed with gentle shaking for about 5 minutes in the buffer solution of Example M, the phosphate buffer solution immersion was repeated two more times. After the three phosphate buffer solution immersions, the microarray was dried using an Argon gas purge. The dried microarray was incubated for 30 to 60 minutes in 10 mM phosphate buffer solution having a pH of about pH 7.4, about 0.1 wt % Tween™ 20 and about 1 wt % bovine serum albumin, then washed three time with the buffer solution of Example K, each wash lasting about a 5 minutes.

### Example O

### Direct Immunoassay of a Carbohydrate Microarray

The microarray of Example N was incubated at ambient temperature for about an hour with one or more fluorescent dye-labeled lectins in the buffer solution of Example M. The concentration of the fluorescent dye-labeled lectin ranges from about 1 pg/mL to about 100 μg/mL. Following the incubation, the microarray was washed twice with the buffer solution of Example L, each washing lasting about 10 minutes, then briefly rinsed with de-ionized water, and dried by centrifugation at 500 g's.

### Example P

### Sandwich Immunoassay of a Carbohydrate Microarray

For sandwich immunoassay, a solution containing one or more biotinalyted lectin/antibody was applied to the surface of the microarray of Example N. The microarray is incubated for about one hour at about 37° C. Following the incubation, the microarray is washed two times for about 8 minutes each with the buffer solution of Example M. A 1 μg/mL of Cy3-labeled streptavidin in a solution of phosphate buffer of Example L was then applied to the surface of the microarray. The microarray was incubated for an hour with. Following the incubation, the microarray was washed twice with the buffer solution of Example M, then briefly rinsed with de-ionized water and dried by centrifugation at 500 g's.

For another type of sandwich analysis, a solution containing one or more lectin/antibody was applied to the surface of the microarray of Example N. The microarray is incubated for about one hour at about 37° C. Following the incubation, the microarray is washed two times for about 8 minutes each with the buffer solution of Example M. The microarray was then incubated for an hour with 5 μg/mL of Cy3-labeled secondary goat anti-IgG in a solution of phosphate buffer of Example M, washed twice with the phosphate buffer of Example M, each washing lasting about 10 minutes, briefly rinsed with de-ionized water, and dried by centrifugation at 500 g's.

### Example Q

### Inhibition Studies Using Microarrays

For inhibition experiments, a series of concentrations of an inhibitor ranging from about 1 uM to about 10 mM were prepared. The inhibitor solutions were mixed with 0.1 mg/mL biotin-ConA in the phosphate buffer of Example M and incubated for about 2 hours before being applied to the microarray surface of one of Examples N, incubated for about one hour at ambient temperature, and then washed twice with the phosphate buffer of Example M, each washing was for about 5 minutes. Following the phosphate buffer washing, the microarray was incubated with 25 μL of 10 μg/mL of cy3-labeled streptavidin in the phosphate buffer of Example M for one hour, washed twice with the phosphate buffer of Example M, each washing is for about 5 minutes.

### Example R

### Microarray Imaging and Data Analysis

The microarrays of Example O was scanned at 10 μm resolution with a ScanArray™ 5000 System (Perkin Elmer™ Life Science) laser confocal fluorescence microscope. The Cy3emitted a fluorescent signal at 570 nm, the Cy3 fluorescent signal was monitored by a photomultiplier tube. The laser power was about 85% and the photomultiplier tube gain was about 75%. The fluorescence signal of each microarray spot and its associated background were quantified by their pixel intensity using an ImaGene™ 3.0 (Biodiscovery™ , Inc. Los Angeles, Calif.) and ScanArray Express™ software programs. A positive staining result was considered if the fluorescent intensity value of the microarray spot was significantly higher than the background intensity. The background intensity was subtracted from the microarray spot, a mean intensity was determined for replicate microarray spots. The mean replicate intensity value was used for data analysis. SigmaPlot™ 5.0 (Jandel Scientific, San Rafael, Calif.) and/or by Microsoft Excel™ were used for statistical analyses.

### Example S

### Synthesis of Bifunctional Dendron for Conjugated Metallic Nanoparticles

A bifunctional dendron ligand bearing nine identical acyl hydrazide coupling points for carbohydrates and a sulfhydryl attachment point to facilitate self-assembly of the dendron onto the surface of metallic and semiconductor nanoparticles. 10 mM of thiodipropionic acid 1, 10 mM of 1-ethyl-3-(3-dimethylaminopropylcarbodimide), and N-hydroxy-succinimide (Sigma-Aldrich, Milwaukee, Wis.) was mixed in DMF for 2 hrs, then 10 mM of three-arm building block Triethyl ester of tris(hydroxymethyl-butanyl)aminomethane was added into the solution. The solution was then stirred at 50° C. for 2 hrs. After that, 5 M KOH solution was added to the solution and the mixed solution was stirred at room temperature for 3 hrs. Extraction with CH₂Cl₂ yieled the triacid compound. The obtained triacid 4 was used for a second round of amide synthesis with the same monomer 2 to provide nona-ester 5. For that, the obtained triacid was mixed in DMF with 10 mM of 1-ethyl-3-(3-dimethylaminopropylcarbodimide), and N-hydroxy-succinimide (Sigma-Aldrich, Milwaukee, Wis.) for 2 hrs, then 10 mM of three-arm building block 2 was added into the solution. The solution was then stirred at 50° C. for 2 hrs. After that, 5 M KOH solution was added to the solution and the mixed solution was stirred at room temperature for 3 hrs. followed by extraction with CH₂Cl₂ yieled the nona-ester 5. 2 M of Hydrazine added to the CH₂Cl₂ extract solution and the stirred at room temperature for 1 hr, which converted each ester to the corresponding acyl hydrazides. The total yield for synthesis of the bifunctional dendron was 10%. Immediately prior to nanoparticle surface modification, the disulfide bond will be reduced by tris-carboxylethyl phosphine (TCEP) to yield the final product having a structure of 600 as shown in FIG. 6H.

### Example T

### Preparation of Glycan Nanoparticles by Conjugation of Carbohydrate Onto Metallic Nanoparticle Surfaces Under Microwave Radiation Energy

The bifunctional dendron from Example S was dissolved in methanol solution at concentration of about 1 ug/mL. The bifunctional dendron/methanol solution was added dropwisely over a time period 30 minutes/hours into a Au colloidal solution having about 10 wt % of about 13 nm Au aqueous colloid (sigma), and incubated at room temperature for at least about 12 hours. The Au colloidal solution was centrifuged, the Au colloid sediment was washed with 1 mM phosphate buffer, and resuspended in an Eppendorf tube with 1 milliliter of 1 mM phosphate buffer. A 10 nM of Mannose in 1 mM phosphate buffer solution was added drop-wise to 1 milliliters of a 10 wt % the Au colloid in an aqueous solution. The resulting solution was subjected to microwave radiation. The microwave radiation was for about 1 to about 10 minutes at about 50% of the maximum 850 watt power of the microwave oven. After the microwave treatment, the Au colloidal solution was centrifuged, the Au sediment isolated, and resuspended in an Eppendorf tube with 1 wt % bovine serum albumin in the phosphate buffer solution of Example M.

### Example U

### Preparation of Glycan Nanoparticles by Conjugation of Carbohydrate Onto Semiconductor Nanoparticle Surfaces Under Microwave Radiation Energy

(a) Synthesis of core-shell QDs. Cadmium oxide (127 mg) and dodecanoic acid (160 mg) were mixed in a 100 mL two necked round bottom flask fitted with nitrogen inlet. The flask was heated at ˜280° C. till the solution becomes color less. Then, trioctylphosphine oxide (TOPO, 1.94 g) and hexadecylamine (1.94 g) were added to a stirring solution and was heated above 280° C. in a rotamantle. Upon reaching the desired temperature (i.e., 350, 330 and 310° C. for the green, orange and red emitting QDs, respectively) the mantle was removed and a solution of selenium powder (80 mg) in trioctylphosphine (TOP, 2 mL) was rapidly injected with vigorous stirring. The color of the solution changed from color-less to green to yellow to red and deep red. For the epitoxial coating of ZnS around CdSe, the flask temperature was lowered to ˜200° C. After three minutes a solution containing mixture of hexamethyldisilathiane ((TMS)2S, 250 mL), diethylzinc (Et2Zn, 1 mL) and TOP (2 mL) was injected dropwise (for 10-15 min). The reaction mixture was heated at 180° C. for another hour before cooling to room temperature. The solution containing TOPO capped CdSe—ZnS was diluted with chloroform and precipitated with minimum of methanol. The QD precipitate was isolated by centrifugation and the same process was repeated and re-suspended in chloroform.

The surface exchange of TOPO-capped QDs with pyridine was performed by heating a solution of CdSe—ZnS in chloroform with pyridine (three times the volume of chloroform) at 60° C. in an open vial for 3 h. The pyridine solution was precipitated with hexane and centrifuged. The obtained precipitate was redissolved in pyridine, and this stock solution was used for further reactions.

Surface Capping of CdSe—ZnS QDs with bifunctional dendron 600. Water solubilization and surface functionalization of CdSe—ZnS was achieved in a single step by covalently coupling QDs with bifunctional dendron 600 from Example S (FIG. 6H). The bifunctional dendron 600 (8 mg) was dissolved in doubled distilled water (50 μL) and DMSO (200 μL) in a microcentrifuge tube. To this solution was added a known concentration of pyridine-capped CdSe—ZnS (2.5 mg) in pyridine (200 μL). The thiol coupling with the ZnS shell of CdSe—ZnS was initiated by adding tetramethylammonium hydroxide (˜5 μL, pH≅10.5) in methanol. The whole mixture was quickly vortexed and centrifuged. The obtained precipitate was resuspended in 50 μL of distilled water and centrifuged (15 000 rpm for 5 min) again. Resuspension and centrifugation were repeated three times to remove excess sugar derivatives. Finally, the precipitate was dissolved in water at pH≅7 (by adding ˜3 μL of 10% AcOH/water) to get a clear solution.

(c) conjugation carbohydrate to dendron-functionalized CdSe—ZnS QDs: A 10 nM of Mannose in 1 mM phosphate buffer solution was added drop-wise to 500 μL above prepared dendron-functionalized CdSe—ZnS QDs in aqueous solution. The resulting solution was gentle mixed and was subjected to microwave radiation. The microwave radiation was for about 1 to about 10 minutes at about 50% of the maximum 850 watt power of the microwave oven. After the microwave treatment, the Mannose conjugated CdSe—ZnS QDs solution was centrifuged, sediment isolated, and resuspended in an Eppendorf tube with 500 μL bovine serum albumin in the phosphate buffer solution of Example M.

A number of variations and modifications of the invention can be used. It would be possible to provide for some features of the invention without providing others.

For example in one alternative embodiment, the surface cleaner 223 and the surface agent 300 comprise one of more of the same substances, as for example, the piranha solution. It can be appreciated that, in such instances the clean substrate 225 and modified substrate 233 are the same.

In another embodiment, the substrate 235 is provided, in step 221, in a substantially clean state and the substrate as provided, in step 221, is substantially activated. In such instances the cleaner 223 and substrate agent 300 (of step 231) are optional. Or stated another way, when the substrate 235 of step 221 is substantially clean and activated the first substance 500 can be applied to substrate 235 and step 231, cleaner 223, and surface agent 300 can be omitted for the process depicted in FIG. 2.

In yet another embodiment, while the dendrimer functional groups 621 typically have the substantially the same chemical functionality they in certain instances have differing chemical functionalities when the dendrimeric branches differ in their functional groups.

In yet another embodiment, the above-described method is used to produce a single-format, as in the case of carbohydrate conjugated nanoparticles. In this embodiment, the substrate is in the form of a nanoparticle.

The present invention, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1-29. (canceled)

30. A method of making a carbohydrate substance, comprising:
(a) providing a nanoparticle substrate having a surface comprising at least one site for attaching a dendrimer;
(b) contacting the substance with at least one dendrimer, each dendrimer including a plurality of surface groups, wherein two or more of the surface groups are configured to attach to a carbohydrate, and wherein at least one of the surface groups is configured to attach to the at least one site of the nanoparticle surface;
(c) immobilizing the at least one dendrimer on the nanoparticle substrate; and
(d) contacting with a carbohydrate-containing fluid, while the nanoparticle substrate is in contact with the carbohydrate-containing fluid applying energy to the nanoparticle substrate and/or carbohydrate-containing fluid to form a carbohydrate substance having multivalent carbohydrate sites for bindings interactions with one or more proteins, lectins, antibodies, DNA and peptides; and
Wherein the carbohydrate is a plysaccharide.

31. (canceled)

32. The method of claim 34, wherein the wherein the linking compound is:

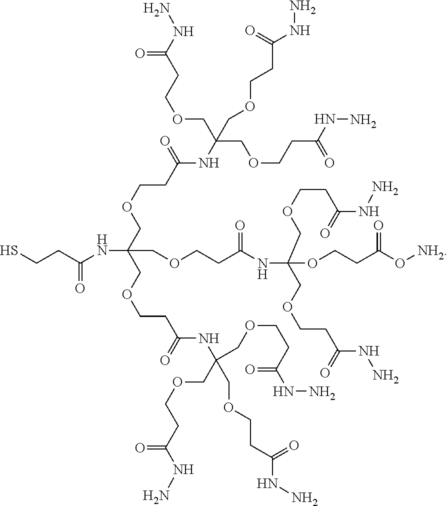

33. The method claim 30, wherein the nanoparticle is selected from the group consisting essentially of gold and (CdSe)ZnS.

34. A method of making a carbohydrate-containing article, comprising:
(a) providing a substrate having a surface comprising at least one site for attaching a carbohydrate;
(b) contacting the substrate with at least one linking compound, the linking compound having a plurality of surface groups configured to attach carbohydrates, wherein the carbohydrate comprises a polysaccharide;
(c) contacting the plurality of surface groups with a carbohydrate-containing fluid;
(d) while the plurality of surface groups are in contact with the carbohydrate fluid, applying heat to the substrate, linking compound, and carbohydrate fluid to form the article, the article having multivalent carbohydrate sites for binding interactions with one or more of proteins, lectins, antibodies, DNA and peptides

35. The method of claim 34, wherein the electromagnetic energy is microwave energy and wherein the microwave energy power ranges from about 300 to about 1800 watts.

36. The method of claim 34, wherein the electromagnetic energy is microwave energy and wherein the microwave energy ranges from about 0.3 GHz to about 300 GHz.

37. The method of claim 34, wherein the electromagnetic energy is microwave energy and wherein the microwave energy power level ranges from about 25% to about 100%.

38. The method of claim 34, wherein the electromagnetic energy is microwave energy and wherein the microwave energy exposure time ranges from about 1 minute to about 30 minutes.

39. The method of claim 34, wherein the substrate is selected from the group consisting essentially of one of glass, semiconductor, organic polymer, membrane, quartz, silicon, mineral, metal, metal alloy, gold, silver, and mixtures and compositions thereof and wherein the article is one of a microarray and a solid nanoparticle.

40. The method of claim 34, wherein the article comprises a plurality of carbohydrates having a plurality of differing chemical compositions and chemical structures.

41. The method of claim 34, wherein the article is a microarray and wherein in step (c): a plurality of carbohydrate-containing fluids are contracted with a plurality of different sites, the carbohydrate-containing fluids comprising differing carbohydrates and each fluid comprises from about 10 nanogram to about 0.01 femtogram of carbohydrate.

42. The method of claim 34, further comprising before step (c):
(e) immobilizing the at least one linking compound on the substrate.

43. The method of claim 34, wherein the plurality of surface groups comprise a plurality of differing chemical functionalities, wherein the surface groups are capable of interacting with the substrate and carbohydrate, wherein the interaction does not require the carbohydrate to be chemically modified, and wherein the interaction maintains substantially at least most of the carbohydrate cyclic structure.

44. The method of claim 34, wherein the interaction of the linking compound and carbohydrate forms a layer, wherein the layer has a thickness ranging from about 2 nm to about 100 nm.

45. The method of claim 34, wherein the linking compound comprises one of:
poly(amido amine) dendrimer;
poly(propoyleneimine) dendrimer;
bifunctional dendron; or
or mixture thereof.

46. The substance of claim 42, further comprising before step (c) and after step (e):
(f) contacting the at least one linking compound with a cross linker, and
(g) cross linking, by the cross linker, the at least one linking compound.

47. The substance of claim 45, wherein the dendrimer has a generation number and wherein the generation number is selected from the group consisting essentially of: generation number 1, generation number 2, generation number 3, generation number 4, generation number 5, and combinations thereof.

48. The method of claim 34, wherein the carbohydrate comprises one or more of the following: polysaccharides of N-Acetyllactosamine and Analogues, Acidic Polysaccharides, Neutral Polysaccharides, acidic polysaccharides containing carboxyl, phosphate and/or sulfuric ester groups.
